(19) United States
(12) Patent Application Publication
(10) Pub. No.: US 2024/0353377 A1
(43) Pub. Date: Oct. 24, 2024

(54) AUTOMATED CHROMATOGRAPHY SYSTEMS AND METHODS

(71) Applicant: Life Technologies Corporation, Carlsbad, CA (US)

(72) Inventors: John P. Greenwood, San Jose, CA (US); Krystle A. PRANTIL, Quincy, MA (US); Declan Crowley, Leeds (GB)

(21) Appl. No.: 18/642,622

(22) Filed: Apr. 22, 2024

Related U.S. Application Data
(60) Provisional application No. 63/497,806, filed on Apr. 24, 2023.
(60) Provisional application No. 63/592,015, filed on Oct. 20, 2023.
(60) Provisional application No. 63/528,848, filed on Jul. 25, 2023.

(51) Int. Cl. G01N 30/20; G01N 30/02; G01N 30/30

(52) U.S. Cl. CPC G01N 30/20; G01N 30/30; G01N 2030/027

(57) ABSTRACT

The present disclosure relates to automated chromatography systems and methods for improving the accuracy of a variety of sensors in a chromatography system and measuring liquid and system parameters of a variety of liquids and bioprocessing equipment used to purify a target molecule. The automated chromatography systems and methods can run a startup operation to generate liquid and sensor parameter sets used in purification operations and recipes for purifying a target molecule in a chromatography column.

### CROSS-REFERENCE TO RELATED APPLICATIONS

This application claims the benefit of the U.S. Provisional Patent Application Ser. No. 63/497,806, filed Apr. 24, 2023, and titled “AUTOMATED CHROMATOGRAPHY SYSTEMS AND METHODS, U.S. Provisional Patent Application Ser. No. 63/528,848, filed Jul. 25, 2023, and titled “AUTOMATED CHROMATOGRAPHY SYSTEMS AND METHODS, and U.S. Provisional Patent Application Ser. No. 63/592,015, filed Oct. 20, 2023, and titled “AUTOMATED CHROMATOGRAPHY SYSTEMS AND METHODS which is incorporated herein by specific reference.

### FIELD

The present application and disclosure relate to automated chromatography systems and methods. More specifically, the present application and disclosure relate to liquid and sensor parameters sets for improving the accuracy of system sensors and optimizing the automation of purification operations.

### BACKGROUND

Column chromatography systems are used in the separation of mixtures. Mixtures can include biological components, such as recombinant proteins, monoclonal antibodies, and viral vectors. The automation of chromatography systems is complicated by the variety of fluids processed, variation in fluid parameters, distinctions in fluid pathways and equipment, and variations in the operation of one or more sensors that measure parameters crucial to process control and automation. In many cases, these complexities can cause false sensor measurements, false alarms, and ultimately hamper efficient automation and process control.

Time-efficient, cost-effective, accurate and optimized automated chromatography systems and methods disclosed herein solve all or some of the above-identified shortcomings and other deficiencies known in the art.

### SUMMARY

In a first aspect of the present disclosure, a method of automating a chromatography system is provided. The method includes flowing a first liquid into the chromatography system that comprises a system controller with a processor and memory for storing instructions; a first conduit with a first inlet; a first valve and a second valve coupled to the conduit; a first sensor coupled to the first conduit and a first sensor transmitter in electronic communication with the system controller; and a first purification column comprising a column inlet fluidically coupled to the first fluid conduit downstream from the first inlet. The method further includes isolating the first liquid between the first valve and the second valve; generating a first sensor parameter at the first sensor transmitter; sending the first sensor parameter from the first sensor transmitter to the system controller; and storing the first sensor parameter in the memory to create a first liquid and sensor parameter set for improving the accuracy of the first sensor. The first sensor parameter can be a processing parameter used to calculate a first liquid parameter of the first liquid. The system controller can also send a first command signal from the system controller to the first sensor transmitter, indicating the presence of the first liquid proximate to the first sensor prior to or after receiving the first sensor parameter from the first sensor transmitter. System controller can also send the first liquid and sensor parameter set to the first sensor transmitter to improve the accuracy of the first sensor. The first sensor parameter can be in analog or digital form, a wave form parameter, an echo value, a dimensionless parameter, or a finite number.

In another aspect of the present disclosure, a method of automating a chromatography system is provided. The chromatography system can include a controller, a processor, a memory for storing instructions, a user input, and a display. The method can include receiving a first input through the user input to select a first liquid and sensor parameter set stored in the memory, wherein the first liquid and sensor parameter set corresponds to a first liquid and a first sensor; receiving a second input through the user input to select a first purification recipe stored in the memory; generating a first output liquid parameter with the processor based on the first liquid and sensor parameter set and a first liquid parameter of the first liquid measured by the first sensor; and displaying the first output liquid parameter at the display. The method can further include sending the first liquid and sensor parameter set from the controller to a first sensor transmitter associated with the first sensor. The first sensor parameter can be in analog or digital form, a wave form parameter, an echo value, a dimensionless parameter, or a finite number.

In another aspect of the present disclosure, an automated chromatography system includes a controller comprising a processor and memory for storing operational instructions and controlling system components; a first conduit with an inlet; a first pump in fluid communication with the inlet; a first valve and a second valve in fluid communication with the first conduit and in electronic communication with the controller; a first sensor coupled to the first conduit and a first sensor transmitter in electronic communication with the controller; a first purification column comprising a column inlet downstream from and in fluid communication with the first inlet; and a first liquid and sensor parameter set stored in the memory, corresponding to a first liquid and the first sensor, and for improving the accuracy of the first sensor. The automated chromatography system can further include a sensor startup operation comprising operational instructions stored in the memory to cause the controller to: operate the pump and flow the first liquid through the first inlet and into the first conduit; close the first and the second valves to isolate the first liquid between the first and second valves; receive, at the system controller, a first sensor parameter from the first sensor transmitter; and store the first sensor parameter in the memory to create the first liquid and sensor parameter set. The automated chromatography system can further include a second sensor coupled to the first conduit; a second sensor transmitter in electronic communication with the controller; and a second liquid and sensor parameter set stored in the memory, corresponding to a second liquid and the second sensor, and for improving the accuracy of the second sensor. The sensor startup operation can further include operational instructions stored in the memory to cause the controller to: operate the pump and flow the second liquid through the first inlet and into the first conduit; close the first and the second valves to isolate the second liquid between the first and second valves; receive, at the system controller, a second sensor parameter from the second sensor transmitter; and store the second sensor parameter in the memory to create the second liquid and sensor parameter set. The sensor parameters can be in analog or digital form, a wave form parameter, an echo value, a dimensionless parameter, or a finite number.

In another aspect of the present disclosure, an automated chromatography system includes a controller comprising a processor and memory for storing instructions and controlling system components; a buffer container; a fluid manifold fluidically coupled to the buffer container; a line-set fluidically coupled to the fluid manifold; a first sensor and a second sensor coupled to the line-set and first sensor transmitter and a second sensor transmitter in electronic communication with the controller; a first purification column fluidically coupled to the line-set and positioned downstream from the first and second sensors; a liquid and sensor parameter set comprising a first sensor parameter and a second sensor parameter stored in the memory for improving the accuracy of the first sensor and second sensor; and a purification recipe comprising a set of operational instructions stored in the memory for purifying a target molecule in the first purification column. The first sensor parameter and the second sensor parameter can be processing parameters used to calculate a first liquid parameter with the first sensor and a second liquid parameter with the second sensor. The first sensor parameter and the second sensor parameter can also be a wave form parameter, an echo value or other sensor parameter used to measure or process liquid parameters. The first sensor and the second sensor can be an air sensor, a flow sensor, a level sensor, or any other sensor. The sensor parameters can be in analog or digital form, a wave form parameter, an echo value, a dimensionless parameter, or a finite number.

In another aspect of the present disclosure, a computing device includes a processor; and a memory storing computer-readable instructions executable by the processor, causing the computing device to receive a first sensor parameter from a first sensor transmitter; and store the first sensor parameter in the memory to create a first liquid and sensor parameter set. The computer-readable instructions executable by the processor can also cause the computing device to send the first liquid and sensor parameter set to the first sensor transmitter. The computer-readable instructions executable by the processor can also cause the computing device to receive a second sensor parameter from a second sensor transmitter; and store the second sensor parameter in the memory to create a second liquid and sensor parameter set. The computer-readable instructions executable by the processor can also cause the computing device to send the second liquid and sensor parameter set to the second sensor transmitter. The sensor parameters can be in analog or digital form, a wave form parameter, an echo value, a dimensionless parameter, or a finite number.

In another aspect of the present disclosure, a computing device includes a processor; and a memory storing computer-readable instructions executable by the processor, causing the computing device to: run a purification recipe comprising a liquid and sensor parameter set and a set of operational instructions for purifying a target molecule in a chromatography system, wherein the liquid and sensor parameter set comprises a first sensor parameter and a second sensor parameter stored in the memory for improving the accuracy of a first sensor and a second sensor in the chromatography system. The first sensor and the second sensor can be an air sensor, a flow sensor, a level sensor or other sensor. The sensor parameters can be in analog or digital form, a wave form parameter, an echo value, a dimensionless parameter, a finite number or other parameter or ratio of parameters used to determine or process measurements from a sensor.

It is understood that each aspect of the present disclosure herein can include any of the features, options, systems components, method steps, and possibilities recited in association with the any other aspect of the present disclosure or other embodiments set forth above or elsewhere within this application.

### BRIEF DESCRIPTION OF THE DRAWINGS

Various embodiments of the present disclosure are discussed with reference to the appended drawings described below. The drawings depict features and embodiments of the systems and methods disclosed and claimed herein. Additions, substitutions, and modifications can be made to features and embodiments specifically depicted in the drawings without departing from the invention or scope thereof. Therefore, the drawings are not to be considered limiting in scope.

FIG. 1A is a block diagram of an automated chromatography system in accordance with example embodiments.

FIG. 1B is a schematic view of a portion of a chromatography unit in accordance with example embodiments.

FIG. 1C is a plot of temperature versus air sensor echo value in accordance with example embodiments.

FIG. 1D is a plot of temperature versus air sensor echo value in accordance with example embodiments.

FIG. 2A is a schematic diagram of a liquid and sensor parameter module of a chromatography system in accordance with example embodiments.

FIG. 2B is a schematic diagram of a system controller and sensor of a chromatography system in accordance with example embodiments.

FIG. 3 is a user interface displayed on a client computing device in accordance with example embodiments.

FIG. 4 is a user interface displayed on a client computing device in accordance with example embodiments.

FIG. 5A is a block diagram of an input/output module for a chromatography system in accordance with example embodiments.

FIG. 5B is a block diagram of a flow meter interface module for interfacing with a flow meter in a chromatography system in accordance with example embodiments.

FIG. 6 is a flow diagram of a method for operating a chromatography system in accordance with example embodiments.

FIG. 7 is a flow diagram of a method for operating a chromatography system in accordance with example embodiments.

FIG. 8 is a block diagram of an example computing device that can perform and automate all operations of example chromatography systems herein disclosed.

### DETAILED DESCRIPTION OF THE PREFERRED EMBODIMENTS

Before describing the present disclosure in detail, it is to be understood that this disclosure is not limited to particularly exemplified apparatus, systems, methods, or process parameters that may, of course, vary. It is also to be understood that the terminology used herein is only for the purpose of describing particular embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, a reference to a “partition” includes one, two, or more partitions.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” or two alternative embodiments of a particular element may be labeled as “10a” and “10b”. In that case, the element label may be used without an appended letter (e.g., “10”) to generally refer to all instances of the element or any one of the elements. Element labels, including an appended letter (e.g., “10a”) can be used to refer to a specific instance of the element or to distinguish or draw attention to multiple uses of the element. Furthermore, an element label with an appended letter can be used to designate an alternative design, structure, function, implementation, and/or embodiment of an element or feature without an appended letter. Likewise, an element label with an appended letter can be used to indicate a sub-element of a parent element. For instance, an element “12” can comprise sub-elements or surfaces “12a” and “12b.”

Various aspects of the present devices and systems may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, systems, and methods may be illustrated with reference to one or more example embodiments. As used herein, the term “embodiment” means “serving as an example, instance, or illustration,” and should not necessarily be construed as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

Automated chromatography systems disclosed herein are used for the separation of biological components or biocomponents. Biocomponents can include biological fluids, solids, mixtures, solutions, and suspensions comprising, for example, media, cells, blood, plasma, organelles, proteins, nucleic acids, monoclonal antibodies, lipids, plasmids, viral vectors, and/or carbohydrates dissolved or dispersed in biological mixtures, solutions, and suspensions. For example, a mixture including a target molecule of interest can be loaded into a chromatography column for separation and purification. A matrix housed within the column is specifically engineered to capture or slow the flow of the target molecule while the remainder of the mixture can more freely flow through and out of the column. Upon eluting the column with a suitable eluant or buffer solution, the target molecule is isolated free of other components. The selection of an appropriate buffer solution is critical and is dependent on the properties of the matrix and the target molecule. An isocratic elution uses a single buffer solution having the same polarity, whereas a gradient elution uses more than one buffer solution and can include a gradual increase or decrease of the polarity of the buffer solution throughout the process of separation.

Chromatography systems herein disclosed use a variety of fluids, equipment, sensors, and purification processes. A common issue arises when integrating a variety of fluids, sensor types, and purification recipes into one automated chromatography system. The variation in liquid, reagent, or buffer fluid properties and inconsistency in sensor type, function, and reliability results in faulty sensor readings and alarms that interrupt and reduce process optimization and yield. Often, sensors of the same type and/or model operate very differently and provide different sensor measurements within a chromatography system, depending on system properties, size of sensor, and even SKU. These issues are common during inline dilution, gradient elution, isocratic elution, and other purification processes where a variety of sensor types, models, or SKUs operate differently and encounter multiple liquids (e.g., buffers, water, multicomponent feed streams, or product streams) and associated concentrations. Upon detecting a false alarm generated by a sensor, the column can be erroneously bypassed or the chromatography process paused to calibrate and/or adjust the sensor, in either case causing loss of product, and delay in processing time. Further, buffer solutions, water or other process liquid(s) remaining within the void volume of the tubing and conduits must be removed and/or collected before re-starting the process. If the false alarms are ignored, it could cause complications at the column stage. Even a small occurrence of faulty sensor readings or alarms can result in significant reductions in yield, sensor replacement, buffer waste, product waste, column fouling, resin fouling, process interruptions, and process shutdown. The example automated chromatography systems disclosed herein address the above complications and problems.

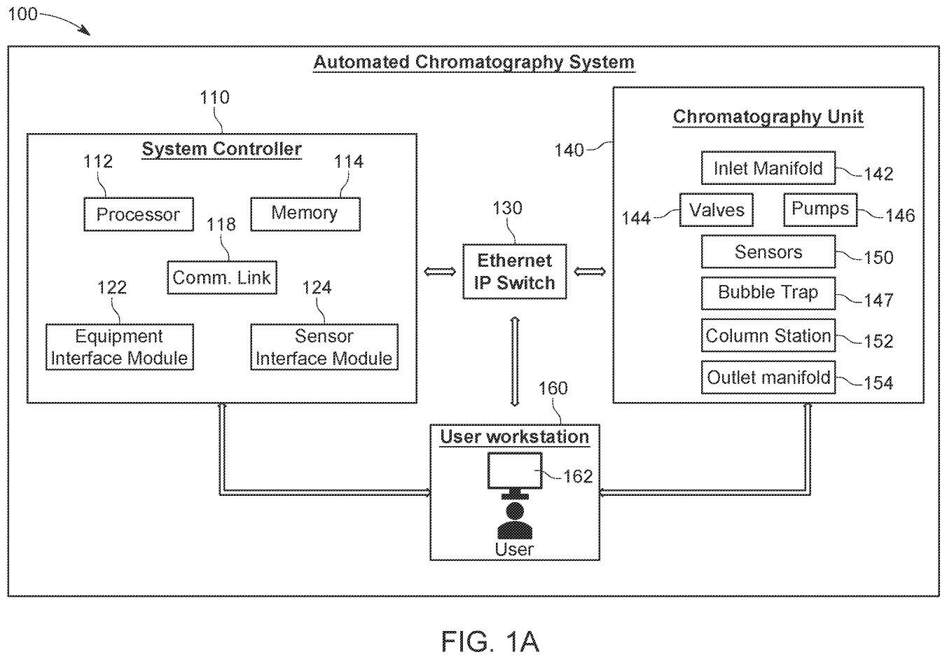

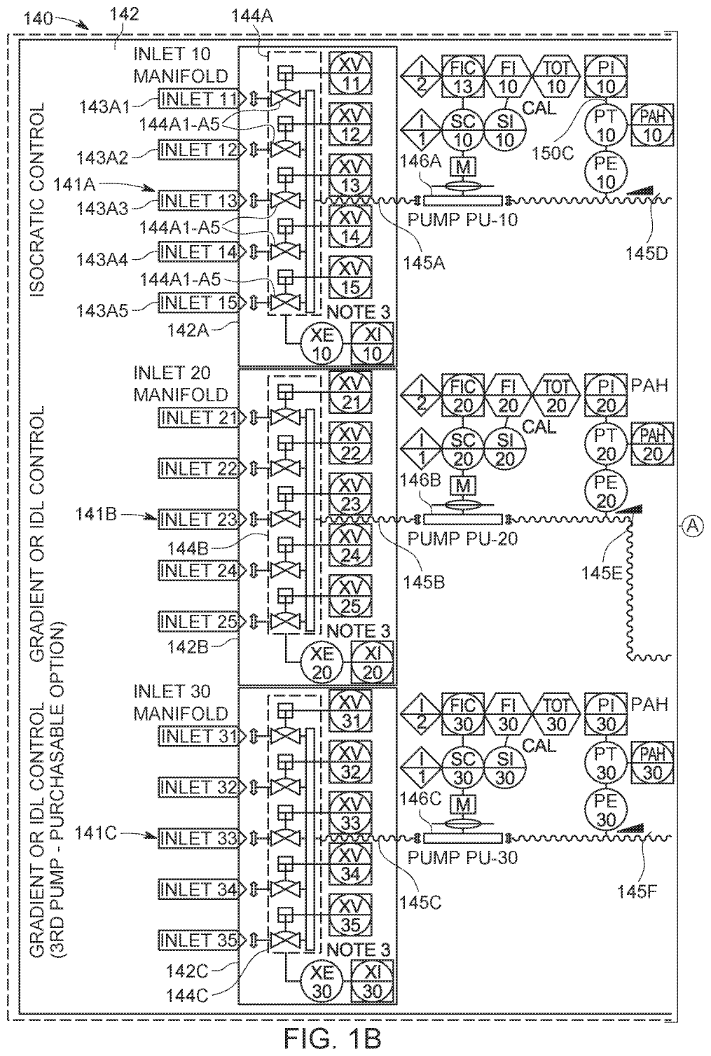

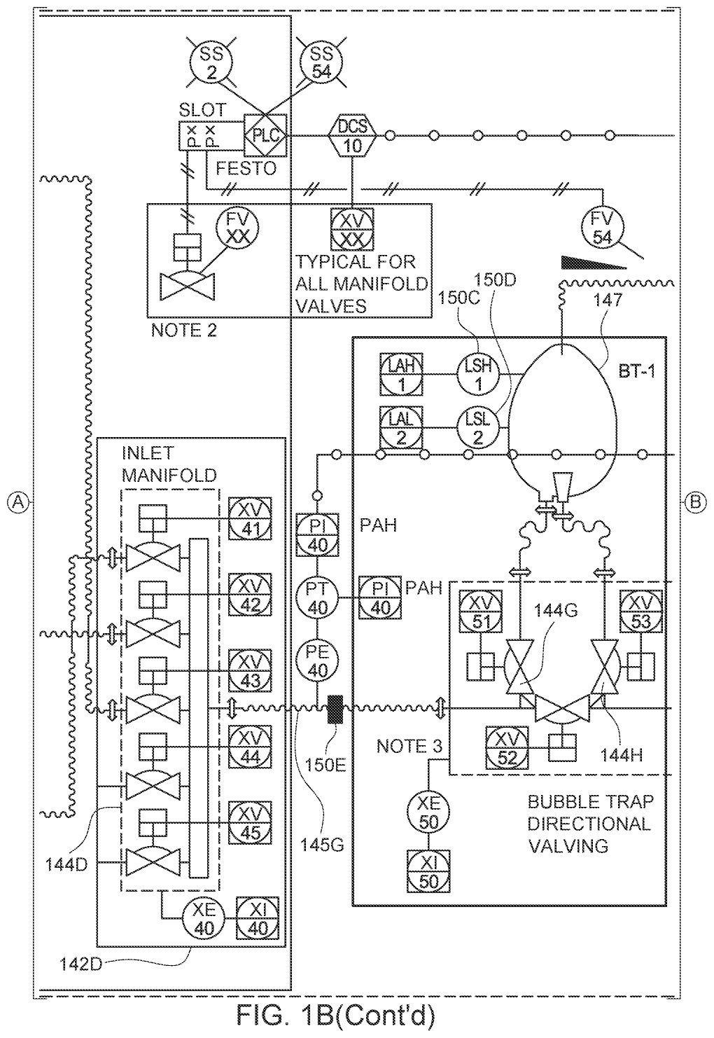

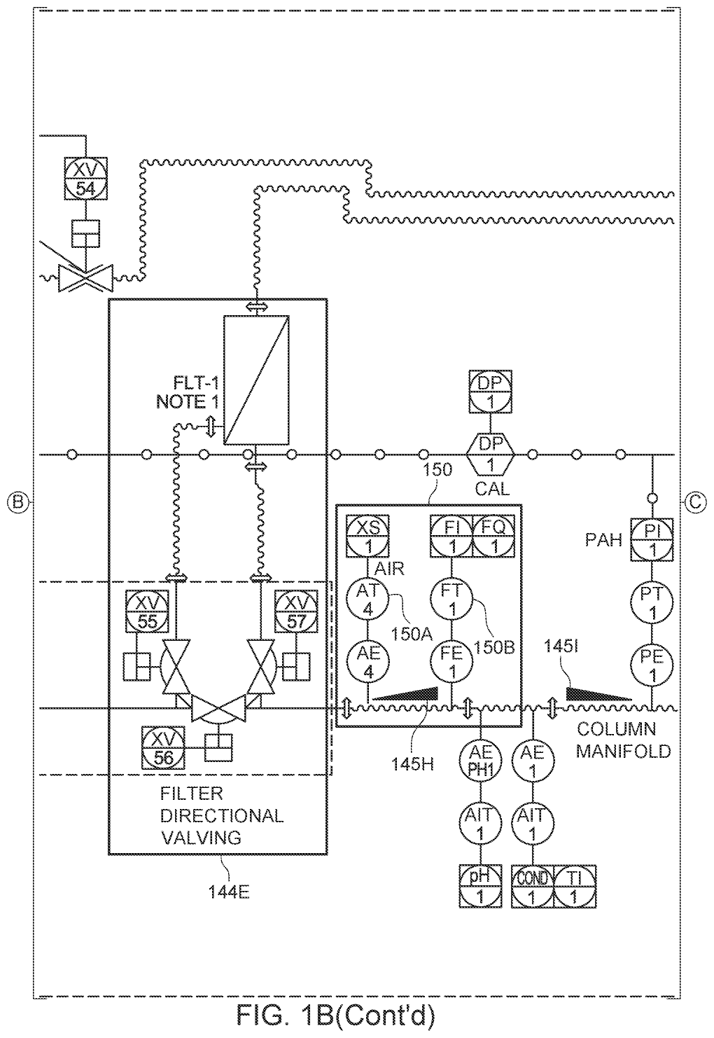

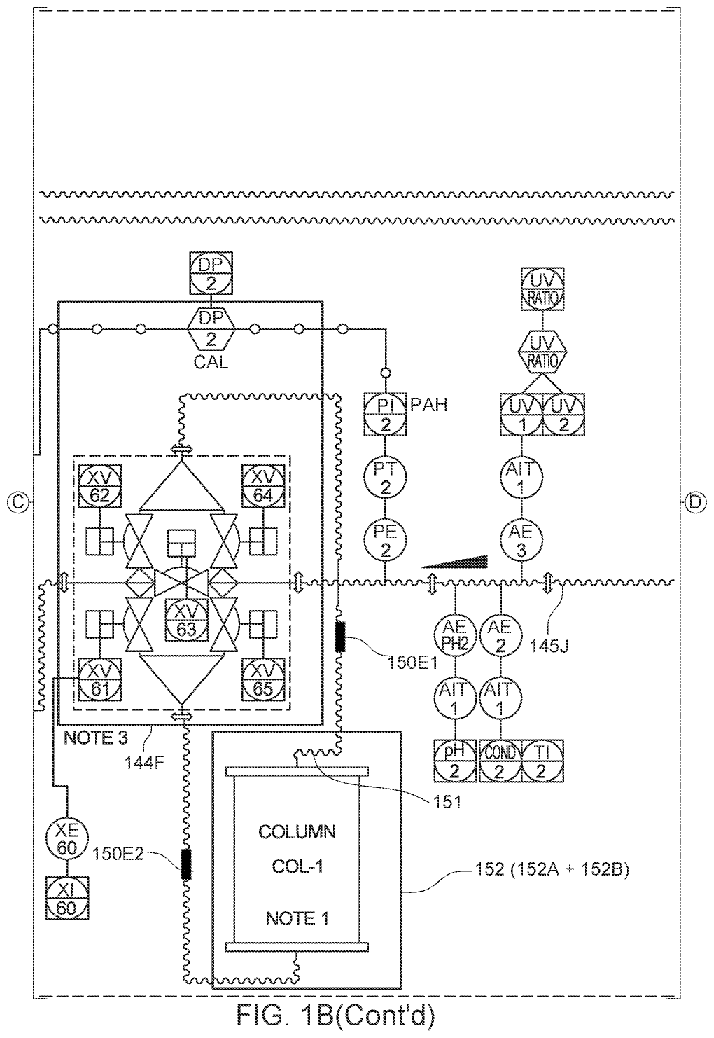

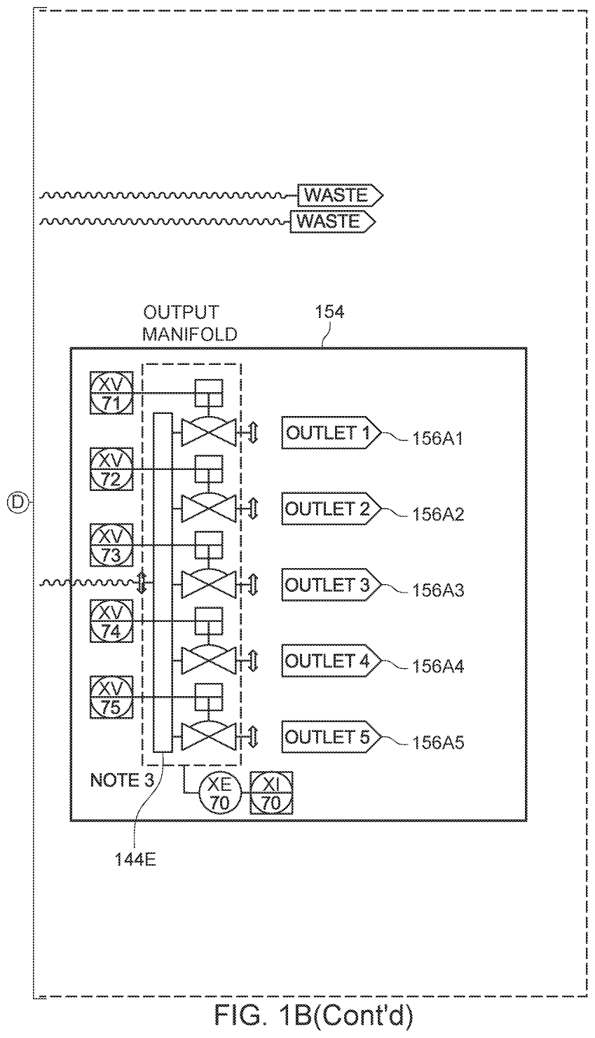

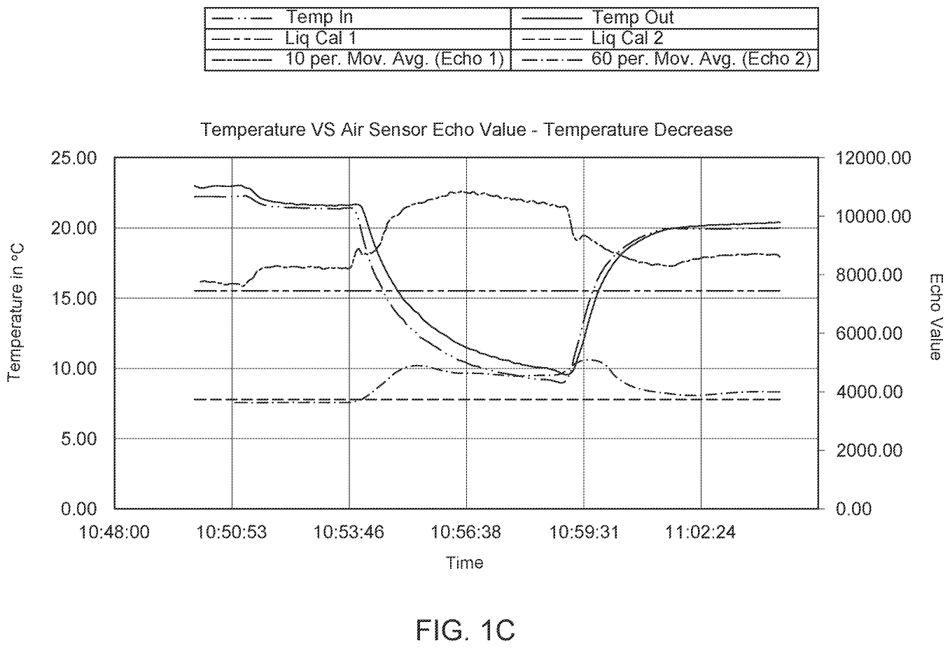

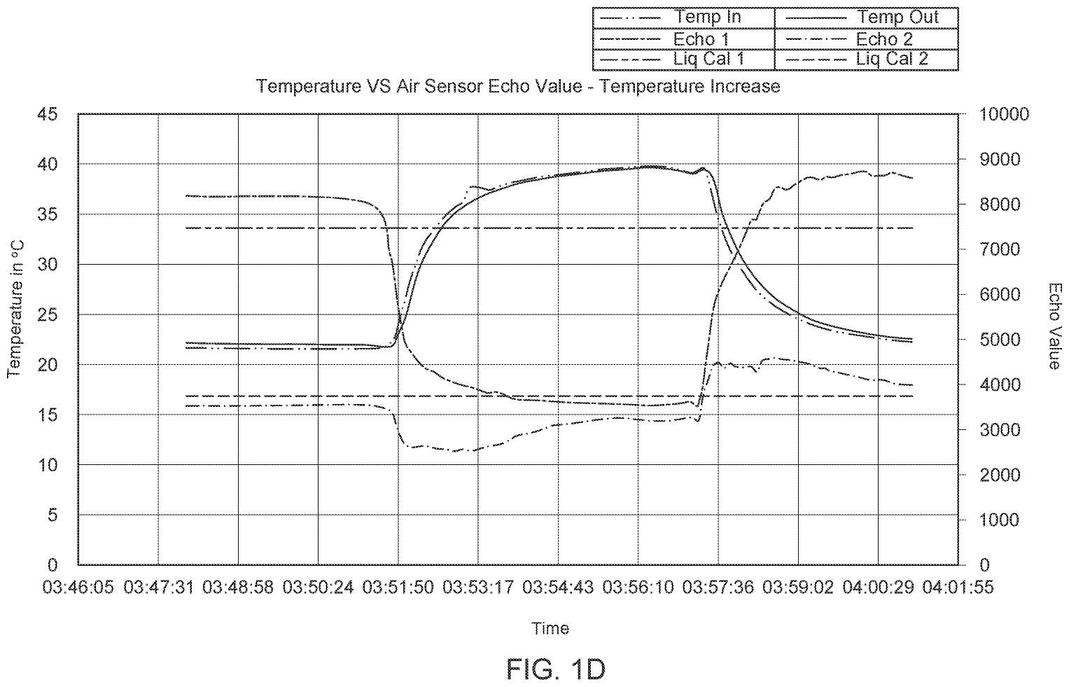

FIG. 1A is a block diagram of an automated chromatography system 100 in accordance with example embodiments. In general, chromatography system 100 is designed to separate a mixture to isolate and collect a molecule(s) of interest from a mixture by a time-efficient and cost-effective automated chromatography protocol. Automated chromatography system 100 can include a system controller 110 in electronic communication with a chromatography unit 140, and a user workstation 160 that can be operated by a user. An Ethernet IP switch 130 (or other communications switch, hub, or router) functions as a router to facilitate and balance communications and data transmission between system controller 110, chromatography unit 140, and user workstation 160. Other communication links, routers, or switches can also be used to facilitate and balance communications and data transmission between system controller 110, chromatography unit 140, and user workstation 160.

System controller 110 includes at least one processor 112 and at least one associated primary memory 114 for storing instructions, which, when executed by at least one processor 112, is configured to perform one or more operations. Further, a communication link 118 facilitates electronic communication between controller 110, chromatography unit 140, and user workstation 160, via Ethernet IP switch 130. Communication link 118 can include any wired and/or wireless network including, for example, a wide area network (WAN), a local area network (LAN), a virtual local area network (VLAN), a public land mobile network (PLMN), the Internet, and/or the like. All data interactions including sending, receiving, writing, overwriting, copying instructions between above components, namely controller 110, chromatography unit 140, sensors 150 and associated transmitters, other components therein, and user workstation 160 can be stored in memory 114.

In some implementations, memory 114 can be a centralized repository designed to store, process, and secure large amounts of structured, semi-structured, and unstructured data. For example, memory 114, can include data sets related to one or more sensors, parameters measured by one or more sensors, fluid parameters, a plurality of process liquids, physical parameters specific to each process liquid, parameters specific to a sensor, and parameters specific to the chromatography unit 140, components thereof, and any other combination of parameters thereof. In other words, memory 114 can be configured to store and/or process, receive, and send the data received from/to chromatography unit 140 and serve as a source of data, inputs, and outputs for user workstation 160. For example, a warehouse receiving a process liquid (e.g., buffer solution) can scan a barcode associated with the process liquid and save parameters associated with the process liquid in memory 114, including liquid and sensor parameter sets, composition, density, specific density, viscosity, mass, heat capacity, volume, temperature and/or other fluid properties of the process liquid. The liquid, sensor, and physical parameters can then be recalled from memory 114 and used during one or more chromatography processes or operations, such as a startup operation or purification operation dictated respectively by a startup recipe or purification recipe. In various embodiments, portions of data stored in memory 114 can be transferred to plant or large-scale applications, while other portions of data can be used for bench-scale applications in a laboratory environment. In some examples, data stored in memory 114 can be used for data analytics and predictive protocols.

Further, system controller 110, includes an equipment interface module 122 and a sensor interface module 124, configured to generally interface with, receive and transmit readings and data to and from one or more operational components, peripherals, or equipment (pumps, valves, inlet/outlet manifolds) associated transmitters and sensors and associated transmitters of the chromatography unit 140. In various embodiments, the system controller 110 can be a single unit or a distributed control system with a client-side control component for client inputs and outputs and a plant-side control component closer in proximity to the bioproduction process or plant.

Chromatography unit 140 can include inlet manifold 142, a plurality of valve units 144 (e.g., automated valve manifolds), a plurality of pumps 146, a plurality of sensors 150, a column station 152, and an outlet manifold 154 (e.g., automated valve manifold), and/or other peripherals, instruments, and equipment used in a chromatography unit 140. A user can control operations of chromatography unit 140 via a user interface 162 displayed on user workstation 160. User interface 162 can include user inputs and readable instrument and process parameter outputs for controlling and monitoring chromatography unit 140 through system controller 110.

In example embodiments, chromatography unit 140 is the Thermo Scientific™ DynaChrom™ Single-Use Chromatography System or similar system. Additional chromatography units 140 and associated features and components are disclosed in WO 2022/126115, which is hereby incorporated by reference in its entirety herein. Chromatography unit 140 can serve as a compact downstream purification system, which is designed to meet the needs of process scale-up and cGMP manufacturing. The DynaChrom™ Single-Use Chromatography System and other example chromatography units 140 can utilize modular, single-use fluid transfer assemblies, industry-standard sensor technology, innovative valve technology, and robust automation. Operations of the chromatography unit 140, including running startup and purification recipes and batches, can be controlled by a system controller 110 (e.g., DeltaV™ PK Controller in combination with TruBio™ and/or TruChrom™ automation software architecture). Operation of one or more valves 144 in inlet/outlet manifolds 142, 154 can be controlled by an automated valve unit or manifold, and corresponding analog or digital input modules, transmitters, communication hubs, communication channels, and/or other communication devices for processing and exchanging data with the controller. An automated flow meter 150 with analog or digital input modules, transmitters, communication hubs, communication channels, and/or other communication devices for processing and exchanging data with the controller can monitor and measure the flow rate and/or other fluid flow parameters of process liquids used in chromatography recipes. An automated air sensor 150 can monitor and measure concentration of air in process liquids or conduits used in chromatography recipes. Automated level sensors 150 can measure the liquid level in various chromatography unit components, such as a bubble trap 147.

FIG. 1B is a schematic view of a chromatography unit 140 in accordance with example embodiments. Chromatography unit 140 includes column station 152 in fluid communication with inlet manifold unit 142 and outlet manifold 154. Inlet manifold unit 142 includes a plurality of primary inlet manifolds 142A-C, connected in parallel, and in fluid communication with respective process liquid containers 141A-C at an upstream location, and to a secondary inlet manifold 142D at a downstream location. Each primary inlet manifold 142A-C is made up of respective valve units 144A-C. Each valve unit 144A-C can include one or more sub-valves. For example, valve unit 144A includes five sub-valves 144A1-144A5. Further, each sub-valve 144A1-A5 can be connected to respective inlet port 143A1-A5 and configured to receive process liquids from the upstream process liquid container 141A. A similar structure can be envisaged for other valve units 144B-C. Further valve units 144A-C can be connected to respective downstream pumps 146A-C by respective line-sets or fluid channels or conduits 145A-C. Further, each of the pumps 146A-C are connected to a secondary inlet manifold 142D by respective line-sets 145D-F. Like primary inlet manifold 142A-C, secondary inlet manifold 142D can also be made up of a valve unit 144D having a structure like valve units 144A-C described above.

Process liquid containers 141A-C (e.g., buffer containers, feed stream containers, or WFI or AWFI containers), primary inlet manifolds 142A-C, and secondary inlet manifold 142D are connected to a downstream column station 152 and further to an outlet manifold 154 by a plurality of additional line-sets 145G-J. Like primary/secondary inlet manifolds 142A-D, outlet manifold 154 can also be made up of a valve unit 144E having a structure like valve unit 144A-D described above. In the example depicted, outlet manifold 154 has five outlets (Outlet 1-5) 156A1-A5 configured to flow out five different aliquots or volumes of process liquids, which can be later collected in storage tanks, pool tanks, or totes. Each of the aliquots can include a process liquid, such as injected water, a solution of a purified product, or a waste buffer solution going to a waste drain.

Pumps 146A-C can be used to flow process liquids from process liquid containers 141A-C, such as water for injection (WFI), ambient water for injection (AWFI), buffer solutions, and/or product load, through the primary inlet manifolds 142A-C, secondary inlet manifold 142D, line-sets 145A-J, column station 152 and out through the outlet manifold 154. The rate and direction of flow of process liquids can be controlled by pumps 146A-C, valve units 144A-D and flow meter 150B disposed across line-sets 145A-J.

Each of the process liquid containers 141A-C can be filled with different process liquids of different fluid properties, concentrations, compositions, and polarities. Each of the inlet manifolds 142A-C can be configured to route process liquids and fluids and run different recipes, including based on isocratic or gradient or in-line dilution (ILD) control. In an isocratic elution, polarity of the buffer solution(s) remains constant over the chromatography separation, while in an ILD or gradient elution the liquid properties, such as viscosity, specific gravity, and polarity, of buffer solution(s) can stay constant or dynamically change over the chromatography separation, startup recipe, or purification recipe.

One or more sensors 150A-E can be coupled to line-sets 145G-J carrying process liquids and can be disposed at pre-column (upstream) and/or post-column (downstream) positions. Sensors 150 (150A and 150B) positioned prior to column station 152 or at pre-column positions are configured to measure process liquid parameters before the process liquid enters column station 152. In the example depicted, sensor 150A can include an air sensor and sensor 150B can include a flow sensor. Sensors 150C, 150D disposed proximate to bubble trap 147, described below, can measure process liquid and system parameters for process liquids flowing through bubble trap 147. Miscellaneous or auxiliary sensor 150E can measure various miscellaneous fluid properties of buffer solutions, injected water, feed streams, or product streams. In FIG. 1B, miscellaneous or auxiliary sensor 150E is shown as positioned upstream from the bubble trap 147, but auxiliary sensor 150E can be positioned anywhere within the chromatography unit 140. Sensors disposed at post-column positions are configured to measure buffer solution, injected water, feed stream or product stream parameters and identify target molecules isolated and carried in the buffer solution after they exit the chromatography station 152. Based on the sensor measurements, system controller 110 is configured to control valve unit 144E to direct process liquid volumes to appropriate outlets 156A1-A5 in outlet manifold 154.

In example embodiments, sensors 150A-E can include one or more sensors that can measure parameters of a fluid or system, including temperature sensors, pressure sensors, mass flow controllers, air sensors, digital pH transmitters, conductivity sensors, turbidity sensors, digital dissolved oxygen transmitters, pH sensors, dissolved oxygen sensors, resistance temperature detectors, proximity sensors, level sensors, thermocouple temperature detectors, or any other sensor for measuring process fluid properties and/or system parameters.

Chromatography unit 140 further comprises a bubble trap 147 disposed downstream from inlet manifold unit 142 but upstream from pre-column sensors 150A, 150B. The bubble trap 147 can remove gases, such as air, from process liquids (e.g., buffer solutions, injected water, feed streams or product streams) to protect chromatography column station 152 by trapping and removing any air in the system, whether from air entrapped in the process fluid, air sucked into the system due to improperly fixed fitting, a dry line condition, a leak, or other conditions. Proximity sensors or level sensors 150C, 150D, such as ultrasonic sensors measure the presence and/or height of liquid (e.g., buffer solution) flowing through bubble trap 147, which can be affected by air bubbles in the liquid.

Column station 152 can comprise one or more chromatography purification columns 152A-B. In an example embodiment, the column station 152, includes a single column 152A with a column inlet 151 or a pair of columns 152A, 152B. In the case of two columns 152A, 152B, each column can be individually connected to and in fluid communication with the different process liquid containers 141A-C (e.g., buffer containers) to purify molecules of interest, or the pair of columns 152A, 152B can be connected in series for continuous feed stream purification.

An appropriate matrix is disposed within each chromatography column 152A, 152B within the unit 152. The chromatography matrix can have a variety of different compositions and/or configurations and is selected or engineered for each use to capture or slow a molecule of interest from a feed stream while the remainder of the feed stream can more freely pass-through chromatography matrix. By way of example and not by limitation, chromatography matrix can comprise a resin or type of filter, such as a porous membrane, that are designed to bind the molecule of interest or target molecule. In more specific embodiments, the chromatography matrix can comprise an ion exchange resin or membrane or a hydrophobic or hydrophilic resin or membrane. In alternative embodiments, as discussed further below, chromatography matrix can be selected so that only the molecule of interest and a related carrier fluid can pass through columns 152A, 152B, while the remaining contaminates within the feed stream, are retained within columns 152A, 152B. The molecule of interest or target molecule can be one or more biological components, fluids, solids, mixtures, solutions, or suspensions including, but not limited to, bacteria, fungi, algae, plant cells, animal cells, white blood cells, T-cells, cell media, protozoans, nematodes, plasmids, viral vectors, blood, plasma, organelles, proteins, nucleic acids, lipids, plasmids, carbohydrates, and/or other biological components.

Conduits 145A-I can be sets of connected conduits (e.g., line sets) or single conduits commonly made from a substantially rigid polymer, co-polymer, polymeric material, such as polycarbonate, poly-methyl methacrylate, polypropylene, or polyvinylidene fluoride (PVDF). Conduits 145A-I can also include single use braided tubing. Other polymers can also be used. Common polymers that are used are thermoplastics. Conduit dimensions including length, diameter and size plays a critical role in designing the conduit network and recipes for chromatography unit 140. In alternative embodiments, other materials can be used such as glass, metal, or composites. It is commonly desired to form conduits 145 from a translucent material so that the flow of fluid through the fluid channels can be easily inspected. However, opaque materials can also be used, such as for processing liquids that are light sensitive.

Isocratic or gradient elution in chromatography unit 140 includes elution with various buffer solutions. One common example of a buffer used as an eluting fluid is 50 mM acetic acid. Other buffers can also be used. Examples of washing fluids can include phosphate and NaCl solutions, more specifically, 50 mM phosphate and 500 mM NaCl. Other fluids, such as buffers that will not detrimentally alter the matrix material, can also be used. Other examples of buffer solutions include a single component or a combination of components, comprising acetic acid, Bis Tris, citric acid, ethanol, HEPES, MES, Sodium acetate, sodium chloride, sodium hydroxide, sodium phosphate, Tris, Ambient water for Injection, Glycine, phosphoric acid, sodium citrate, benzyl alcohol, or formic acid.

A variety of liquids, feed streams, buffer solutions and elution methods can be used during a purification process dictated by a purification recipe. Example process liquids, including buffer solutions, disclosed herein can have different fluid properties and are used to implement different elution schemes and techniques, such as isocratic elution and gradient elution. Prior to running a purification recipe to purify or isolate a target molecule in chromatography unit 140, a system startup recipe can be conducted. The system startup recipe can be used to characterize process fluids and sensors, clear air from the chromatography unit 140, wet and prime system equipment, such as pumps, valves, and conduits (e.g., pumps 146A-C, conduit 145A-J and valves 144A-E), and calibrate system sensors (e.g., 150A-D) for accurately measuring fluid and system parameters. Example startup recipes are particularly critical for the calibration of sensors 150A-D and for accurately measuring one or more liquid and system properties of different liquids, feed streams, buffer solutions and sensors (e.g., air, flow, or level sensors) used to optimize the purification or isolation of target molecules in the chromatography unit 140. Depending on the purification recipe and elution method, different liquids, feed streams, and buffer solutions flowing from process liquid containers 141A-C, can have the same, constant, different or dynamic fluid properties at given times throughout the startup or purification process. For example, the polarity, viscosity, density, and temperature of various buffer solutions can vary or change during purification or remain constant during purification. In an example embodiment, a liquid, buffer or sensor startup recipe can be used to assure that sensors are properly operating and accurately measuring fluid parameters for specific liquids, such as buffers, based on liquid parameters (e.g., viscosity, density, temperature of buffer) and system parameters (e.g., sensor type, conduit size, conduit type, column size, column type, bubble trap dimensions). These startup recipes can be initiated using the automated chromatography systems 100 shown in FIG. 1A.

In an example embodiment, a user can initiate a startup recipe by inputting a command(s) at the user workstation 160 (Shown in FIG. 1A). The startup recipe can cause the system controller 110 to send control signals to sensors 150A-D to measure various fluid or liquid parameters, system parameters, or sensor parameters and/or send the parameters to system controller 110 prior to wetting and when only air is in the chromatography unit 140. The startup recipe can also cause the system controller 110 to wet the chromatography unit 140 by sending control signals to pumps 146A-C and valves 144A-D to power the pumps 146A-C, open and close valves 144A-D, and flow a first process liquid (e.g., injected water, feed stream, or buffer solution) from one or more process liquid containers 141A-C, through one or more inlets 143A1-A5 of inlet manifold 142A, and through the chromatography unit 140.

During system wetting, a first process liquid can be flowed through pumps 146A-C, valves 144A-D, and conduit 145A-I to flush the air and wet the chromatography unit 140 and process equipment depicted in FIGS. 1A-1B. The startup recipe causes system controller 110 to send control signals to a set of valves 144E and 144F to close the valves, stop the flow of liquid, and isolate the first process liquid between the set of valves 144E and 144F. After the process liquid is isolated between a set of valves 144E and 144F, sensors 150A-D can measure various fluid, liquid, or system parameters, generate sensor parameters, and/or send the parameters to system controller 110 with air removed and liquid within the chromatography unit 140. The sensors 150A-D can measure one or more fluid, liquid, and system parameters and generate sensor parameters one at a time or at the same time. System controller 110 can also send control signals to trigger analog or digital sensors 150A-D (or associated transmitters) to send sensor parameters to the system controller 110. The analog or digital sensors 150A-D (or associated transmitters) can also send sensor parameters to system controller 110 automatically, in a timed fashion, or based on stimulus, such as the presence of air or process liquid.

In example embodiments, sensor 150A can be an air sensor used to measure air concentrations in the system or within process liquids. During a startup operation dictated by a startup recipe, sensor 150A can automatically generate sensor 150A parameters or receive control signals and commands from system controller 110 (e.g., cal., zero, or toggle command) that trigger sensor 150A to generate sensor parameters with air or process liquid isolated between a set of valves 144E and 144F within a section of conduit 145H. The air sensor parameters can be sent from sensor 150A or associated transmitter to system controller 110 before and after air is flushed from the conduit 145H. Sensor parameters generated by and sent from sensor 150A can be specific to a liquid (e.g., buffer solution), system configuration (e.g., equipment, conduit diameter, system temperature) and/or the specific sensor (e.g., sensor model, sensor type, sensor SKU). For example, the startup recipe can cause the air sensor 150A to generate one or more sensor parameters (e.g., an echo value, air threshold value, air calibration limit, liquid calibration limit) when the conduit 145H is empty and send the sensor parameters to the system controller 110. The sensor parameters generated when the conduit 145H is empty can be stored in memory 114 of system controller 110. The startup recipe can also cause system controller 110 to flow and isolate a process liquid, such as a buffer solution, in the conduit 145H between the set of valves 144E and 144F (as discussed above), cause the air sensor 150A to generate air sensor parameters, and send the air sensor parameters to system controller 110 for storage in memory 114. In this example of an air sensor startup operation, the sensor parameters can be an echo value of 10-200 with no liquid in the conduit 145H depending on the sensor model or type, and an echo value of 500-8000 with liquid isolated in the conduit 145H depending on the process liquid (e.g., buffer) and the sensor 150A model or type. The generated air sensor parameters are based on the process liquid and sensor type and make-up all or part of a liquid and sensor parameter set.

In specific embodiments during an air sensor startup operation described above, system controller 110 can send a control signal to the air sensor 150A or associated sensor transmitter indicating that no liquid and only air is in the conduit 145H. This signal can be characterized as an air calibration command, zero-command, or a toggle command that can, for example, toggle a value in a data register of the sensor transmitter. In example embodiments, the data register is a 16-bit register with 16-bits of data (e.g., Modbus register). The air calibration or zero-command sent from the controller to the air sensor 150A transmitter can cause a bit within a hold or write register to toggle from 0 to 1. After receiving this air calibration or zero-command, indicating that only air is in the system or conduit 145H, air sensor 150A and associated transmitter generates one or more sensor parameters. One or more air sensor 150A parameter(s) are then sent from air sensor 150A transmitter to system controller 110 for storage in memory 114. The one or more air sensor 150A parameter(s) form all or part of a liquid and sensor parameter set that is specific to liquid and the sensor. The system controller 110 can also receive air sensor parameters automatically, in a timed fashion, or in response to a stimulus (e.g., presence of air or process fluid) from the sensor 150A, without the need for a calibration or zero command. In example embodiments, the air sensor parameter can be an echo value for air, a number value for air, a ratio, or dimensionless parameter for air.

In other embodiments, a specific or predefined sensor parameter (e.g., echo value, number value, and/or dimensionless parameter) corresponding to air can be saved in memory 114 of system controller for an air sensor 150A to generate part of a liquid and sensor parameter set. For example an echo value of 40 (corresponding to air) can be saved in memory 114 of system controller for an air sensor 150A to generate part of a liquid and sensor parameter set.

In specific embodiments during an air sensor startup operation described above, system controller 110 causes the chromatography unit 140 to be primed or wetted with a specific process liquid (e.g., injected water, buffer solution, or feed stream), by flowing the process liquid through the chromatography unit 140 and isolating the process liquid in the conduit 145H between a set of valves 144E and 144F by closing the valves (as discussed above). After process liquid isolation, system controller 110 sends a control signal to the air sensor 150A or associated sensor transmitter indicating that a process liquid is in the conduit 145H. This signal can be characterized as liquid calibration command, a zero-command, or a toggle command that can, for example, toggle a value in a data register of the sensor transmitter. In example embodiments, the data register is a 16-bit register with 16-bits of data (e.g., Modbus register). The zero-command sent from the system controller 110 to the air sensor 150A transmitter can cause a bit within a hold or write register to toggle from 0 to 1 (or some other value). After receiving this liquid calibration or zero-command, indicating that a process liquid is in the system or conduit 145H, air sensor 150A and associated transmitter generates one or more sensor parameters. One or more air sensor 150A parameter(s) are then sent from air sensor 150A transmitter to system controller 110 for storage in memory 114. The one or more air sensor 150A parameter(s) form all or part of a liquid and sensor parameter set that is specific to the process liquid and the sensor isolated between the set of valves 144E and 144F. The system controller 110 can also receive air sensor parameters from the sensor 150A automatically, in a timed fashion, or in response to a stimulus (e.g., presence of air or process fluid), without the need for a calibration or zero command. In example embodiments, the air sensor parameter can be an echo value, finite number, a ratio, and/or dimensionless parameter for the specific process liquid and sensor.

In other example embodiments, the system controller 110 can generate an air detection threshold by dividing the air sensor parameter for air (e.g., echo value for air) by the air sensor parameter for a process liquid (e.g., echo value for the process liquid) generated during a startup operation for a specific sensor. Echo values or other sensor/dimensionless parameters generated by the air sensor 150A that are above (or below) the air detection threshold indicate the presence of air in the specific process liquid or in the system for the specific sensor in use. The air detection threshold can alternatively be generated by dividing the sensor parameter (e.g., echo value) for the process liquid by the sensor parameter (e.g., echo value) for air. The air detection threshold can be stored in memory 114 of system controller 110 to generate part of a liquid and sensor parameter set.

The liquid and sensor parameter sets described above can be called, used and/or sent by system controller 110 to air sensor 150A transmitters during a purification operation dictated by a purification recipe to improve accuracy of the sensor and optimize purification. Sensor 150A startup operations and the liquid and sensor parameter sets, are therefore, specific to and tailored for the specific liquids (e.g., water, feed stream, or buffer), chromatography system components (e.g., equipment, size of conduit 145A-I), and/or specific sensors (e.g., sensor type, model, SKU, or air sensor diameter) used in the system and during purification.

In specific embodiments during an operation, including air sensor 150A described above, system controller 110 causes the chromatography unit 140 to be primed or wetted with a process liquid. For example, the process liquid can include buffer solutions that include a single component or a combination of components, comprising ambient water for injection. For example, air sensor 150A can include an AQ air sensor coupled to an ultrasound controller D72 or DP72 or any other air sensor capable of measuring air in conduits or air in process liquids flowing through conduits in chromatography unit 140. All wetted parts of the air sensor 150A can be made of acid-proof steel (Model CCS, Model SAC, and Model FCS) or polypropylene (Model PAC, Model FCP, Model APS). Air Sensor 150A can be configured as CIP (Clean in Place) or SIP (Steam in Place) up to 130° C. The air sensor 150A can be set on different sensitivity levels. At high sensitivity, the air sensor 150A can detect bubbles as small as 2 mm, and at low sensitivity, the air sensor 150A can detect the presence of liquid or no liquid. In particular, the description below is related to the initialization and/or calibration of the air sensor 150A for temperature variations of various process liquids flowing through the chromatography unit 140.

The air sensor 150A on the chromatography unit 140 can use sound waves or ultrasound beams at one or more wavelengths to determine the presence of air in the process liquids. In an example embodiment, two low-intensity ultrasound beams are transmitted orthogonally to the process liquid flow path through the sensor 150A. When the process liquid has air, it deflects at least one of the ultrasound beams, causing a fluctuation in the measured sensor parameter or echo value. This fluctuation can be attributed to air in the process liquid. A signal level or echo value from the beams through the liquid (without air) is established as a threshold echo value, and values measured in subsequent measurements having echo values below that threshold indicate the presence of air. Additionally, the air sensor 150A can be sensitive to the temperature of the process liquid that the sensor is evaluating. A thermal management process for chromatography unit 140 can achieve an increase or decrease in the temperature of process liquids. The thermal management process can be configured to heat or cool the process liquid above and below the ambient temperature. The thermal management process can include running the chromatography process in a refrigerated room, lowering the temperature, or the process liquid being heated/cooled in a separate vessel and applied to the system. Alternatively, an assembly for the thermal management of process liquids can be built into the chromatography system 140. For example, the working temperature range achievable for the process liquid by the thermal management assembly can be 0° C. to 50° C. An advantage of increasing or decreasing the temperature of the process liquid during a purification recipe in the chromatography system can include obtaining better effective separation characteristics of a target product or enhancing product stability.

FIG. 1C depicts a plot of temperature versus air sensor echo value as the temperature of the process liquid is decreased over a period of time. In example embodiments, the process liquid is flowed through the chromatography unit 140, and the process liquid is isolated in the conduit 145H between a set of valves 144E and 144F by closing the valves (as discussed above). After process liquid isolation, the system controller 110 sends a control signal to the air sensor 150A or associated sensor transmitter indicating that a process liquid is in the conduit 145H. This signal can be characterized as a liquid calibration command, a zero-command, or a toggle command. After receiving this liquid calibration or zero-command, indicating that a process liquid is in the system or conduit 145H, air sensor 150A and associated transmitter generate one or more sensor parameters for a predetermined time period, thereby generating calibration line-1 or ‘Liq Cal 1’, and calibration line-2 or ‘Liq Cal 2’ for two different wavelengths of the ultrasound waves. The plurality of data points on the line for ‘Liq Cal 1’ corresponding to the echo value of the process liquid at two different wavelengths over the predetermined time period are then sent from the air sensor 150A transmitter to system controller 110 for storage in memory 114 as part of sensor parameter set specific for the process liquid. One or more air sensor 150A parameter(s) form all or part of a liquid and sensor parameter set that is specific to the air sensor 150A and the process liquid isolated between the set of valves 144E and 144F. The system controller 110 can also receive air sensor parameters from the sensor 150A automatically, in a timed fashion, or in response to a stimulus (e.g., the presence of air or process fluid) without the need for a calibration or zero command. In example embodiments, the air sensor parameter can be an echo value, finite number, ratio, and/or dimensionless parameter specific for the process liquid and air sensor.

In example embodiments, the system controller 110 can send commands to a pair of miscellaneous or auxiliary sensors 150E1, and 150E2 (e.g., temperature sensors), positioned upstream and downstream, respectively, from column station 152, to measure the temperature of the process liquid entering and exiting column station 152 over a pre-determined time period. Miscellaneous or auxiliary sensors 150E1 and 150E2 can be temperature sensors configured to measure the temperature of process fluids. A temperature variation for the process liquid, when process liquid enters and exits out of column unit 152, is shown by lines ‘Temp In’ and ‘Temp Out,’ respectively. The plurality of data points on the lines ‘Temp In’ and ‘Temp Out’ correspond to the temperature of the process liquid entering and exiting out of column station 152 measured by the miscellaneous sensors 150E1, 150E2. The plurality of data points on the lines ‘Temp In’ and ‘Temp Out’ can also form part of the miscellaneous sensor parameter data set specific for the process liquid and the miscellaneous sensors 150E1, 150E2. The system controller 110 can send instructions to air sensor 150A to record sensor parameters particular to the process liquid and the air sensor 150E when the temperature of the process liquid changes or decreases. Variations in sensor echo values for a specific process liquid over a period of time when the temperature of the process liquid decreases is shown in lines ‘Echo 1’, and ‘Echo 2’, respectively, for the two ultrasound beams having two different wavelengths. The moving averages for echo values with noises removed are depicted. The plurality of data points on the lines ‘Echo 1’ and ‘Echo 2’ corresponds to the echo values for the process liquid measured by the air sensor for the two ultrasound beams having different wavelengths and form a part of the sensor parameter data set specific for the process liquid, air sensor 150A and the miscellaneous sensors 150E1, 150E2.

FIG. 1D depicts a plot of temperature versus air sensor 150A echo value over a period of time as the temperature of the process liquid is increased. In both cases, when the temperature of the process liquid is increased or decreased, echo values measured for process liquids can vary inversely with the temperature of the process liquids. In other words, a decrease in temperature increases the echo value, and an increase in temperature decreases the echo value. Thus, echo values from sensor 150A can be used to (i) determine if air or liquid is present in the sensor; (ii) determine the type of liquid as the echo value is unique for every process liquid; (iii) determine if the process fluid is at the predetermined temperature. In the characterization of process liquids that are used on the chromatography system 140, thresholds are established for each liquid at “ambient” temperature. Process liquid characterization, including the type of process liquid, the composition of process liquid, the concentration of process liquid, and ascertaining physical parameters like temperature, viscosity and density, can occur using a combination of sensors, including the air sensor 150A and miscellaneous sensors 150E1 and 150E2.

In another example embodiment of a startup operation dictated by a startup recipe, sensor 150B can be a flow sensor or flow meter used to measure flow rates of process liquids and generate flow sensor parameters for specific process liquids (e.g., injected water, buffer solution, or feed stream), system configurations (e.g., equipment, conduit diameter, system temperature) and/or the specific sensors (e.g., sensor model, sensor type, sensor SKU, or sensor diameter). System controller 110 causes the chromatography unit 140 to be primed or wetted with a specific process liquid (e.g., injected water, buffer solution, or feed stream), by flowing the process liquid through the chromatography unit 140 and isolating the process liquid in the conduit 145H between a set of valves 144E and 144F (e.g., by closing the valves as discussed above). After process liquid isolation, system controller 110 sends a control signal to the flow sensor 150B or associated sensor transmitter indicating that a process liquid is in the conduit 145H. This signal can be characterized as a liquid calibration command, zero-command, or a toggle command that can, for example, toggle a value in a data register of the sensor transmitter. In example embodiments, the data register is a 16-bit register with 16-bits of data (e.g., Modbus register). The liquid calibration or zero-command sent from the system controller 110 to the flow sensor 150B transmitter can cause a bit within a hold or write register to toggle from 0 to 1 (or some other value). After receiving this liquid calibration or zero-command, indicating that a process liquid is in the system or conduit 145H, flow sensor 150B and/or associated transmitter generates one or more sensor parameters. The one or more flow sensor 150B parameter(s) are then sent from flow sensor 150B transmitter to system controller 110 for storage in memory 114. The one or more flow sensor 150B parameter(s) form all or part of a liquid and sensor parameter set that is specific to the process liquid and the sensor isolated between the set of valves 144E and 144F. The system controller 110 can also receive flow sensor parameters automatically, in a timed fashion, in response to a stimulus (e.g., presence of air or process fluid), and/or in digital form (e.g., digital value) from the sensor 150A, with or without the transmission of a calibration or zero command. In example embodiments, the flow sensor 150B parameter can be a wave form parameter, a finite number, or a dimensionless parameter for a specific process liquid and sensor. The generated flow sensor parameters (e.g., wave form parameter, a finite number, or a dimensionless parameter) are based on the liquid/buffer and sensor type, and therefore, constitute part of a liquid and sensor parameter set.

In another example embodiment of a startup operation dictated by a startup recipe, a user can initiate a startup recipe by inputting a command(s) at the user workstation 160 (shown in FIG. 1A). The startup recipe can cause the system controller 110 to send control signals to sensors 150C-D to generate sensor parameters or measure various fluid, liquid, or system parameters and send the parameters to system controller 110 with only air in a bubble trap 147. The system controller 110 can also send control signals to pumps 146A-C and valves 144A-D to power the pumps 146A-C, open and close valves 144A-D, and flow a first liquid (e.g., injected water, feed stream, or buffer solution) from one or more process liquid containers 141A-C, through one or more inlets 143A1-A5 of inlet manifold 142A, and through the chromatography unit 140. This flow control also causes liquid to partially fill the bubble trap 147 or fill the bubble trap 147 to a designated liquid level or height. The startup recipe can also cause the system controller 110 to send control signals to a set of valves 144G and 144H to close the valves, stop the flow and isolate a first process liquid between the set of valves 144G and 144H and within the bubble trap 147. After the liquid is isolated between a set of valves 144G and 144H, system controller can send a control signal or zero-command to sensors 150C-D or associated transmitters, sensors 150C-D or associated transmitters can generate sensor parameters, and sensors 150C-D or associated transmitters can send the sensor parameters to system controller 110 for storage in memory 114. The system controller 110 can also receive flow sensor parameters automatically, in a timed fashion, in response to a stimulus (e.g., presence of air or process fluid) or in digital form (e.g., digital value) from the sensor 150A, with or without the transmission of a calibration or zero command. A digital sensor parameter value can also be received by system controller after a call or ping command.

In example embodiments, sensors 150C, 150D are proximity or level sensors (e.g., ultra-sonic sensors) disposed at different positions or heights next to or on the bubble trap 147. For example, level sensor 150C can be positioned at a higher level of elevation on or next to the bubble trap 147 relative to level sensor 150D positioned at a lower level on or next to the bubble trap 147. Depending on the fluid level within the bubble trap 147, one or both level sensors 150C, 150D can measure the presence of liquid isolated within the bubble trap 147. The proximity sensors 150C, 150D can detect a change in electric field, magnetic field, capacitance, conductivity, light, vibration, or other measurable change when a liquid is proximate to the sensor and within the bubble trap 147.

In an example startup operation dictated by a startup recipe, the level sensors 150C, 150D can be used to measure the air or a liquid level isolated in the bubble trap 147, generate level sensor parameters, and send the level sensor parameters to the system controller 110 for storage in memory 114 when the bubble trap 147 is filled with air and when the bubble trap 147 is filled with liquid.

In specific embodiments of a level sensor startup operation described above, system controller 110 can send a control signal to one or more level sensors 150C-D or associated sensor transmitter indicating that no liquid and only air is in the conduit 145H. This signal can be characterized as an air calibration command, zero-command, or a toggle command that can, for example, toggle a value in a data register of the sensor transmitter. In example embodiments, the data register is a 16-bit register with 16-bits of data (e.g., Modbus register). The zero-command sent from the controller to the level sensor 150C-D transmitters can cause a bit within a hold or write register to toggle from 0 to 1. After receiving this zero-command, indicating that only air is in the system or in conduit 145H, level sensors 150C-D and associated transmitters generate one or more sensor parameters. One or more level sensor 150C-D parameter(s) are then sent from level sensor 150C-D transmitters to system controller 110 for storage in memory 114. The system controller 110 can also receive level sensor parameters automatically, in a timed fashion, in response to a stimulus (e.g., presence of air or process fluid) or in digital form (e.g., digital value) from the sensors 150C-D, with or without the transmission of a calibration or zero command. The one or more level sensor 150C-D parameter(s) form all or part of a liquid and sensor parameter set that is specific to air and the sensors 150C-D. In example embodiments, the level sensor parameter can be an echo value for air, a digital parameter, a finite number, dimensionless parameter, or some threshold parameter indicating no liquid in the bubble trap 147.

In other embodiments, a specific predefined sensor parameter (e.g., echo value for air, a digital parameter, a finite number, dimensionless parameter, or some threshold parameter) corresponding to air can be saved in memory 114 of system controller for a level sensors 150C-D to generate part of a liquid and sensor parameter set. For example, an echo value of 40 (corresponding to air) or digital parameter value corresponding to air can be saved in memory 114 of system controller for level sensors 150C-D to generate part of a liquid and sensor parameter set.

In specific embodiments during a level sensor startup operation described above, system controller causes the chromatography unit 140 to be primed or wetted with a specific process liquid (e.g., injected water, buffer solution, or feed stream), by flowing the process liquid through the chromatography unit 140 and isolating the process liquid in the bubble trap 147 between a set of valves 144G and 144H (e.g., by closing valves as discussed above). After process fluid isolation, system controller 110 can send a control signal to one or more level sensors 150C-D or associated sensor transmitters indicating that a process liquid is in the bubble trap 147. This signal can be characterized as a liquid calibration command, zero-command, or a toggle command that can, for example, toggle a value in a data register of the sensor transmitter. In example embodiments, the data register is a 16-bit register with 16-bits of data (e.g., Modbus register). The liquid calibration or zero-command sent from the controller to the level sensor 150C-D transmitter can cause a bit within a hold or write register to toggle from 0 to 1 (or some other value). After receiving this zero-command, indicating that a process liquid is in the system or bubble trap 147, level sensors 150C-D and associated transmitters generate one or more sensor parameters. The level sensors 150C-D and associated transmitters can also be digital and send a digital sensor parameter, echo value, a finite number, dimensionless parameter, or some threshold parameter automatically, in a timed fashion, or in response to a ping from the system controller 110. One or more level sensor 150C-D parameter(s) are then sent from level sensor 150C-D transmitters to system controller 110 for storage in memory 114. The one or more level sensor 150C-D parameter(s) form all or part of a liquid and sensor parameter set that is specific to the process liquid and the sensors isolated between the set of valves 144G and 144H. In example embodiments, the level sensor 150C-D parameters can be a digital parameter, echo value, or other sensor parameter for the specific process liquid and sensor proximate to the bubble trap 147.

In other example embodiments, the system controller 110 can generate a liquid detection threshold by setting a predetermined value for the sensor parameter or by dividing the level sensor parameter for air in the bubble trap 147 by the level sensor parameter for a specific process liquid in the bubble trap 147 (or vice versa) generated during a startup operation for a specific sensor. Subsequent sensor parameter values generated by the level sensors 150C-D that are above (or below) the liquid detection threshold indicate the presence of liquid in bubble trap 147 for the specific level sensor in use. The liquid detection threshold can be stored in memory 114 of system controller 110 to generate part of a liquid and sensor parameter set.

The liquid and sensor parameter sets described above can be called, used and/or sent by system controller 110 to level sensor 150C-D transmitters during a purification operation dictated by a purification recipe to improve accuracy of the level sensors, improve detection of gas bubbles in the bubble trap, and optimize purification. startup operations for level sensors 150C-D and the liquid and sensor parameter sets, are therefore, specific to and tailored for the specific liquids (e.g., water, feed stream, or buffer), chromatography system components (e.g., equipment, size of conduit 145A-I), and/or specific level sensors (e.g., sensor type, model, SKU, or air sensor diameter) used in the system and during purification.

As part of the above-described sensor 150A-D startup operations/recipes, any number of specific process liquids or buffer solutions can be isolated between a set of valves 144E-H, and all fluid flow is allowed to stop, fill, or partially fill within the isolated section of conduit 145H or in the bubble trap 147. Sensors 150A-D or associated sensor transmitters can generate one or more sensor parameters (e.g., echo value, digital parameter, wave form parameter, or dimensionless parameter) or after receiving a calibration, control, or zero-command from the system controller 110. These sensor parameters can be generated for any number of process liquids and sent from sensor transmitters to the system controller 110 for storage in memory 114 to create a library of liquid and sensor transmitter sets corresponding to specific liquids and sensors. The liquid and sensor parameter sets can then be called, used and/or sent by the system controller 100 to sensor 150A-D transmitters during a purification operation/recipe to improve accuracy of the sensor and optimize purification. Sensor 150A-D startup operations and the liquid and sensor parameter sets, are therefore, specific to and tailored for the specific liquids (e.g., water, feed stream, or buffer), chromatography unit 140 components (e.g., equipment, size of conduit 145A-I), and/or specific sensors (e.g., sensor type, model, SKU, sensor size or diameter) used in the system and during purification operations. Sensor parameters referenced in this specification can equally be referred to as sensor transmitter parameters, such as echo values, wave form parameters, dimensionless parameters and other processing parameters used by sensors and sensor transmitters to provide accurate sensor measurements.

To further optimize and increase the accuracy of sensors 150A-150D during a startup operation dictated by a startup recipe, system controller 110 can also automatically receive or send control signals to cause one or more miscellaneous sensor(s) 150E to send miscellaneous liquid or system parameter measurements to system controller 110 for storage in memory 114. Miscellaneous sensor(s) 150E can include, but are not limited to, pressure sensors, flow rate sensors, air sensors, pH sensors, temperature sensors, proximity sensors, valve position sensors, dissolved oxygen sensors, carbon dioxide sensors, foam sensors, cell density sensors and/or other sensors capable of measuring liquid parameters (e.g., temperature of the liquid), system parameters (e.g., conduit size, pump power, pressure, column size, column porosity, valves sizes), or biological feed or product parameters (e.g., cell density of cell culture solution carrying target molecule). Example miscellaneous liquid parameter measurements can include, but are not limited to, viscosity, pressure, density, specific gravity, volume, pH, temperature, cell density, dissolved oxygen concentration, carbon dioxide oxygen, turbidity, mass, heat capacity, and/or other fluid properties of the process liquid corresponding to the sensor startup procedure or operation. As disclosed herein, the process liquid can be injected water, a feed stream, product stream, buffer, buffer solution or other liquid used during a startup or purification operation in the chromatography unit 140. Example miscellaneous system parameter measurements can include, but are not limited to, temperature, pressure, rpm, conduit size, bubble trap wall thickness, air concentration, oxygen concentration, valve position, or other parameter within or associated with a piece of equipment (e.g., pump, bubble trap, section of conduit, chromatography column, valve, or valve manifold). These miscellaneous (or auxiliary) liquid and system parameter measurements can also be sent to system controller 110 for storage in memory 114 to form part of a liquid and sensor parameter set that can be called, used, or sent to one or more sensor transmitters to improve the accuracy of one or more sensors during purification. Miscellaneous liquid and system parameters can also be input into memory 114 by an operator. In an example embodiment, a buffer viscosity and temperature are miscellaneous liquid parameters that form part of a liquid and sensor parameter set to improve accuracy of a sensor measuring liquid properties of the buffer during a purification operation.

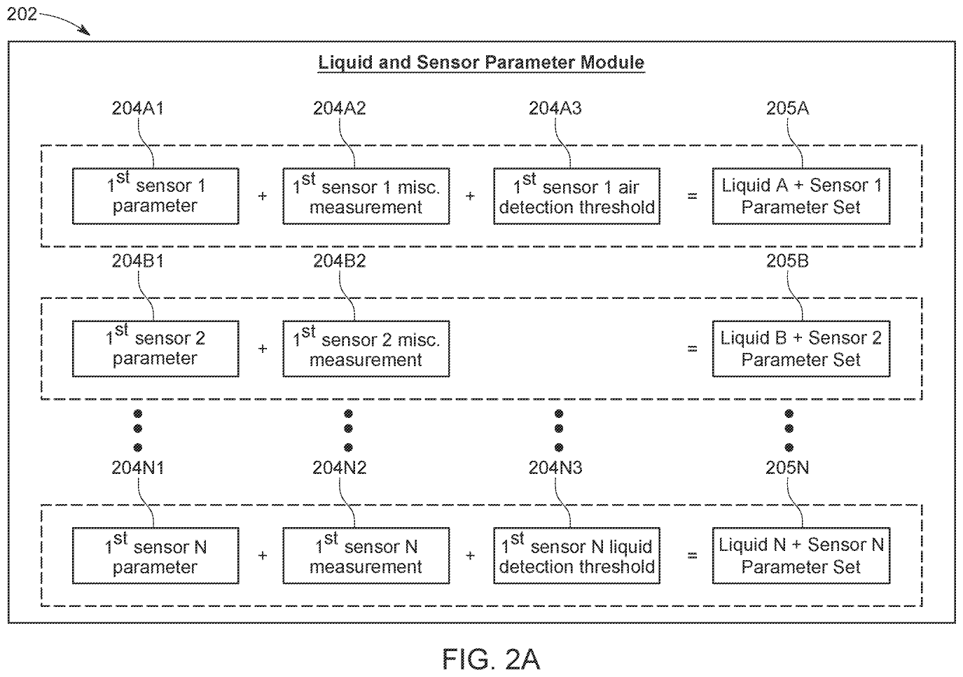

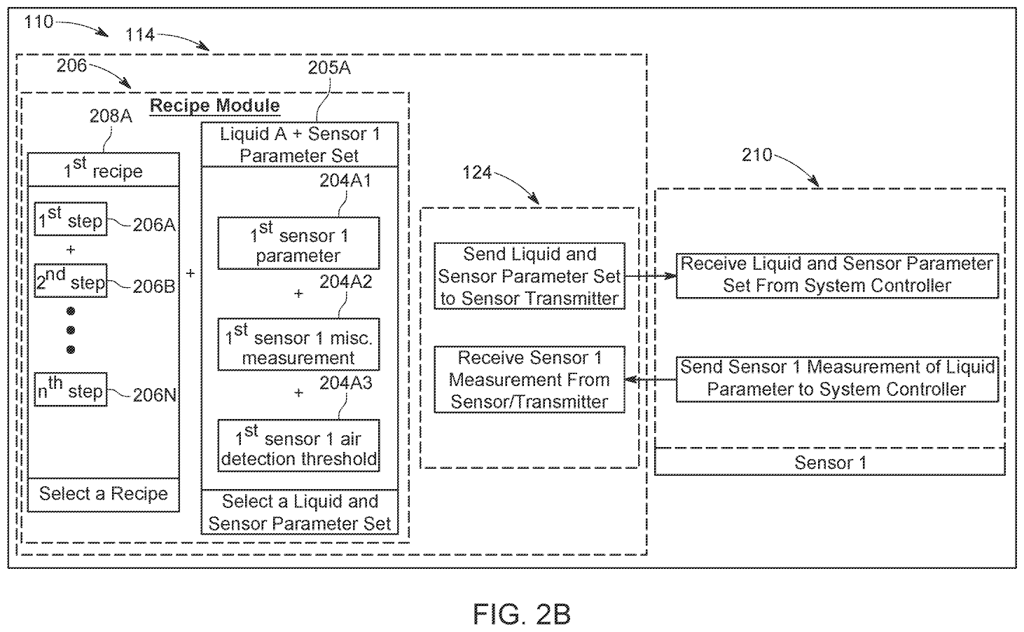

FIG. 2A is a schematic diagram of a liquid and sensor parameter module 202 of a chromatography system in accordance with example embodiments. The liquid and sensor parameter module 202 is a database or library that can be stored in memory 114 of system controller 110. The liquid and sensor parameter module 202 can include a database or library of liquid and sensor parameter sets 205A-205N that correspond to and are specific to a sensor (1, 2, . . . N) and liquid (A, B, . . . N) combination. Each liquid and sensor parameter set 250A-205N can be composed of one or more sensor parameters, miscellaneous sensor measurements, and or sensor detection thresholds including: (1) sensor parameters 204A1, 204B1, . . . 204N1 from primary sensors 1-N being setup, zeroed, or calibrated through a startup operation; (2) miscellaneous sensor measurements 204A2, 204B2, . . . 204N2 sent from miscellaneous or auxiliary sensors 150E before, during or after a startup operation; and/or (3) an air detection threshold or liquid detection threshold generated or determined by selecting a threshold or combining two or more sensor parameters. Together or individually, one or more of these sensor parameters, measurements, or detection thresholds make-up one or more liquid and sensor parameter sets 205A, 205B, 205N constituting a set of sensor transmitter settings or zero values for each sensor (e.g., sensors 1, 2, . . . N or 150A-D) and each liquid type (e.g., A, B, . . . N, or other process liquids).

In reference to FIGS. 1A, 1B and 2A, during a startup procedure dictated by a startup recipe, these sensor measurements and parameters can be received, stored, processed, modified and/or transmitted by system controller 110, processor 112, memory 114, equipment interface module 122 and sensor interface module 124 interfacing with sensors 150A-D and chromatography unit 140 equipment. For example, the equipment interface module 122 can interface and communicate with, receive signals/data from, and send signals/data to chromatography unit 140 equipment, such as process liquid containers 141A-C, inlet manifold 142, valves 144A, fluid conduits 145A-J, pumps 146A-C, column station 152, columns 152A-B, and outlet manifold 154. Likewise, sensor interface module 124 can interface and communicate with, receive signals/data from, and send signals/data to sensors 150A-D, auxiliary/miscellaneous sensor 150E and associated sensor transmitters. These sensor measurements/readings and parameters forming the liquid and sensor parameter sets 205A-205N can also be transmitted to an inventory management system or layer, such as a manufacturing execution system (MES) or enterprise resource planning system (ERP) for syncing process liquid barcodes corresponding to a specific process liquid (e.g., injected water feed stream, product stream, or buffer) with specific liquid and sensor parameter set(s) 205A-205N. Each time an operator scans a barcode associated with a specific process liquid, the MES or ERP can pull, combine, and/or sync liquid and sensor parameter set(s) 205A-205N with a specific process liquid to send to specific sensor transmitters and/or for use in a purification recipe.

Sensor parameters 204A1-204N1, can be received from primary sensors 152A-D through communication link 118 at the sensor interface module 124, stored in memory 114, and processed by processor 112 of the system controller 110 to generate part of the liquid and sensor parameter set(s) 205A-205N for the liquid and sensor module 202. Likewise, miscellaneous sensor measurements 204A4-204N4 can be received from miscellaneous sensor(s) 150E through communication link 118 at the sensor interface module 124, stored in memory 114, and/or processed by processor 112 of the system controller 110 to generate part of the liquid and sensor parameter set(s) 205A-205N for the liquid and sensor module 202. As disclosed herein, sensor parameters 204A3-204N3 are generated by a specific sensor 152A-D and sent to system controller 110 for storage in memory 114 during a startup process to generate part of the liquid and sensor parameter set(s) 205A-205N for the liquid and sensor module 202. Together, one or more liquid and sensor parameter set(s) 205A-205N make up a library of calibrated liquid and sensor parameters that are specific and tailored to the process liquids, sensors, and equipment used in the chromatography unit 140 to purify a target molecule. These libraries, including liquid and sensor parameter set(s) 205A-205N, can be stored, called, processed during a purification operation, or sent to primary sensors 152A-D (or their corresponding sensor transmitters) during a purification operation dictated by a purification recipe. Liquid and sensor parameter set(s) 205A-205N can be included and used in purification recipes to optimize sensor accuracy, process control, and automation of the chromatography unit 140.

The process liquids disclosed herein can vary by constituents, polarity, viscosity, density, specific gravity, temperature, or any other measurable fluid parameter. Likewise, system parameters, such as conduit sizes, pump power, column size, column porosity, valves sizes, valve types, pressure, bubble trap type, and pressure loss across the system components can also vary across chromatography systems. As a result, various sensors 150A-D in the chromatology unit 140 and their corresponding measurements can vary drastically and inaccurately based on the process liquids and system equipment/components used. Startup operations and recipes can be run for any number of process liquids A . . . N (e.g., buffer solutions, injected water, feed stream, or product stream) and any number of sensor(s) 1 . . . N, including sensor types, models, SKUs, or sizes to generate liquid and sensor parameter set(s) 205A-205N. The liquid and sensor parameter set(s) 205A-205N account for these anomalies, variations, and inaccuracies caused by varying liquid and sensor types, drastically improving the sensor accuracy, process control, and automation of the chromatography unit 140.

FIG. 2B is a schematic diagram of a system controller 110 and sensor/transmitter 210 of a chromatography system in accordance with example embodiments. System controller 110 includes memory 114 and processor (not shown) for storing and running recipe module 206 and sensor interface module 124. The recipe module 206 can store or include one or more recipes 208A, including operational steps 206A-N, that cause the system controller 110 to control and automate equipment (e.g., pumps, valves, sensors, bubble traps, column temperature) in the chromatography unit 140 (e.g., shown in FIG. 1B). The recipe module 206 can also include, store, call, or use one or more liquid and sensor parameter sets 205A to improve accuracy of sensors and optimize automation and control of the purification process. As discussed in reference to FIG. 2A, liquid and sensor parameter sets 250A-205N can be composed of: (1) sensor parameters 204A1, 204B1, . . . 204N1 from primary sensors 1-N being setup, zeroed, or calibrated through a startup operation; (2) miscellaneous sensor measurements 204A2, 204B2, . . . 204N2 sent from miscellaneous or auxiliary sensors 150E before, during or after a startup operation; and/or (3) a sensor detection threshold generated or determined by selecting a predetermined value or combining two or more sensor parameters.

In the example depicted in FIG. 2B, one liquid and sensor parameter set 250A corresponding to a specific Liquid A and Sensor 1 and transmitter 210 combo can be called or used by a recipe 208A stored in the recipe module 206. The liquid and sensor parameter set 250A can then be sent from system controller 110, through sensor module 124, and to a sensor transmitter 210 associated with Sensor 1 to improve the accuracy of Sensor 1. Sensor 1 can then take a measurement of a liquid parameter (e.g., air concentration, flow rate, liquid level) and send the measurement of the liquid parameter back to the system controller 110 through the sensor module 124 to facilitate process control according to the recipe (e.g., purification recipe). The measurement of a liquid parameter by Sensor 1 is based on the and improved by the liquid and sensor parameter set used in a purification recipe 250A and/or sent to the sensor transmitter 210 during a purification operation. The output liquid parameter can also be displayed at the user interface 162 at a user workstation 160 (shown in FIG. 1A). In example embodiments, Sensor 1 can be an air sensor, flow sensor, level sensor, or other sensor, and the liquid parameter can be an air concentration within Liquid A, a flow rate of Liquid A, or liquid level of Liquid A within a piece of equipment (e.g., bubble trap), or another liquid parameter. In example embodiments, Liquid A is injected water, a process feed stream, a buffer, or buffer solution.

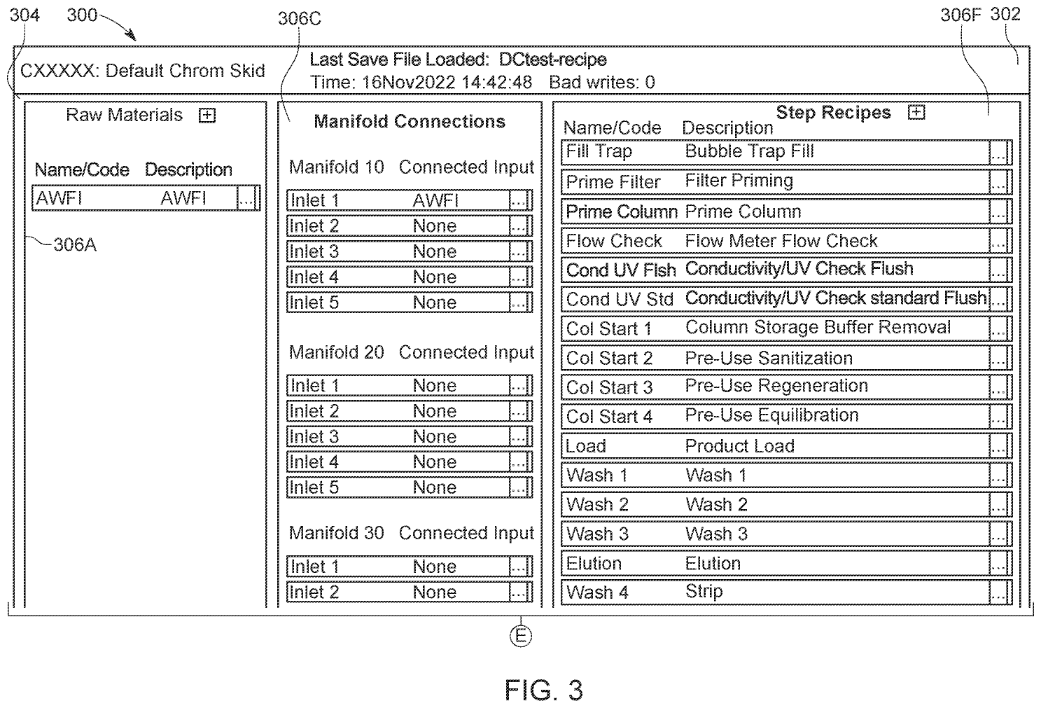

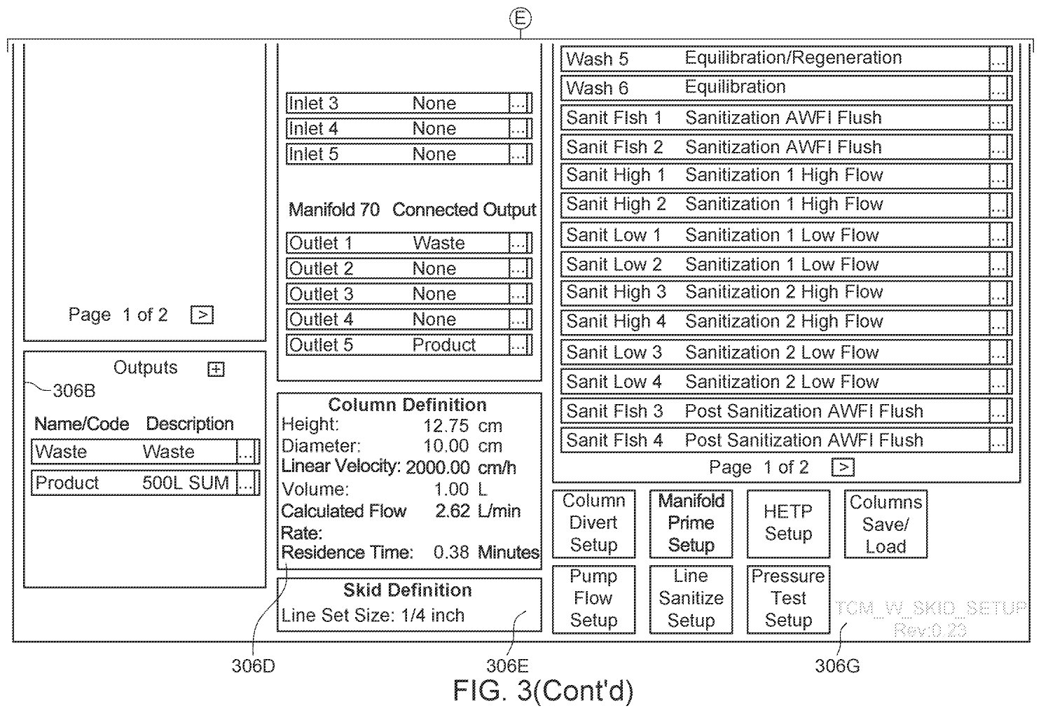

FIG. 3 is a user interface displayed on a client computing device in accordance with example embodiments. In general, user interface 300 is an example of the user interface 162 that can be displayed at user workstation 160 (shown in FIG. 1). User interface 300 enables an operator to select and/or view chromatography system setup parameters and purification recipe components, including raw materials fed into the chromatography system, process liquids used, equipment setup parameters, output parameters, manifold and fluid flow path parameters, column parameters, line set sizes, and different startup and purification recipe steps. Specifically, user interface 300 can be used to define one or more sub steps in a startup or purification recipe of interest. User interface 300 can include a screen and display 302 (touch screen/display or other physical input) and a graphical user interface 304 with one or more selection areas 306A-F. First selection area 306A displays virtual input/output controls related to the selection of raw materials for a startup or purification recipe. For example, selection area 306A displays a liquid of “Ambient water for Injection (AWFI)” and a dropdown menu list enabling an operator to select other liquids and buffers of interest to flow through a chromatography unit (e.g., chromatography unit 140). Second selection area 306B displays virtual input/output controls related to outputs for startup or purification recipes of interest. For example, selection area 306B displays outputs indicating a product from a 500LSingle Use Mixer and a Waste output from the chromatography unit 140. Third selection area 306C enables an operator to select and setup inlet/outlet manifold connections with a source of liquid (e.g., buffer solution of interest, injected water, feed stream, product stream, or waste stream). For example, inlet-1 of manifold 10 includes a fluid connection to an AWFI, whereas outlet 1 of manifold 70 includes a waste stream, and outlet 5 of manifold 70 includes a fluid connection to a product stream. Fourth and fifth selection areas 306D, and 306E display outputs related to the chromatography column (Height, Diameter, Linear Velocity, Volume, Calculated Flow rate, Residence time, etc.) and skid definition (Line-set size), respectively. Sixth selection area 306F displays a list of recipe steps and components with respective descriptions to enable an operator to select components of a recipe of interest listed under the name/code and description of the recipe step. User interface 300 also includes one or more input buttons in selection area 306G related to a column divert setup, manifold prime setup, HETP setup, column types to save/load, pump flow setup, line sanitize setup, and pressure test setup operations.

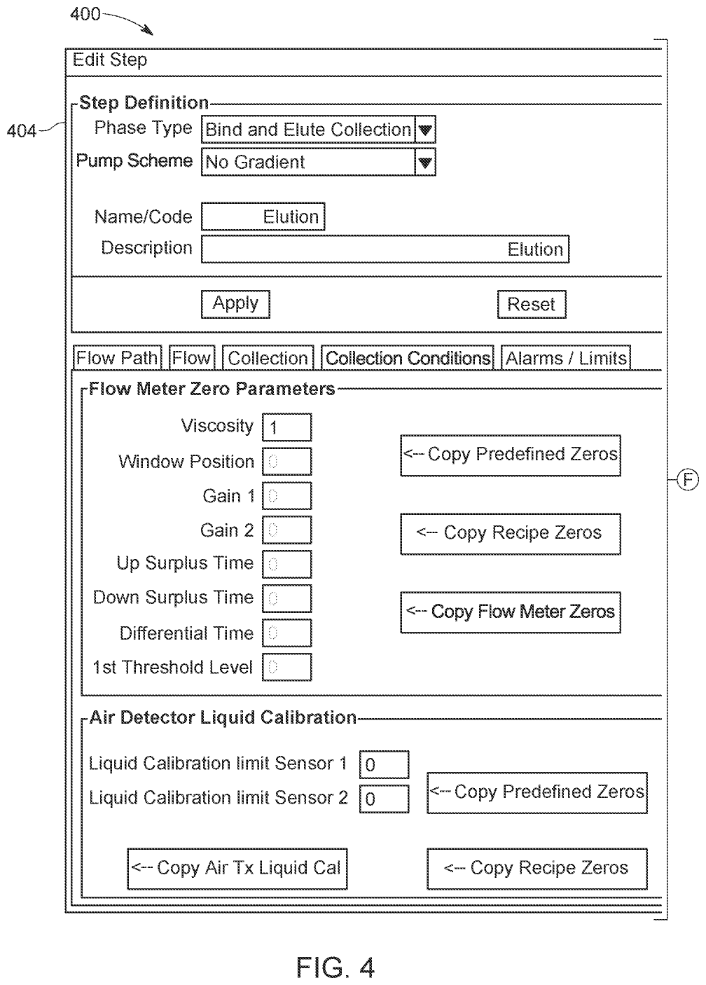

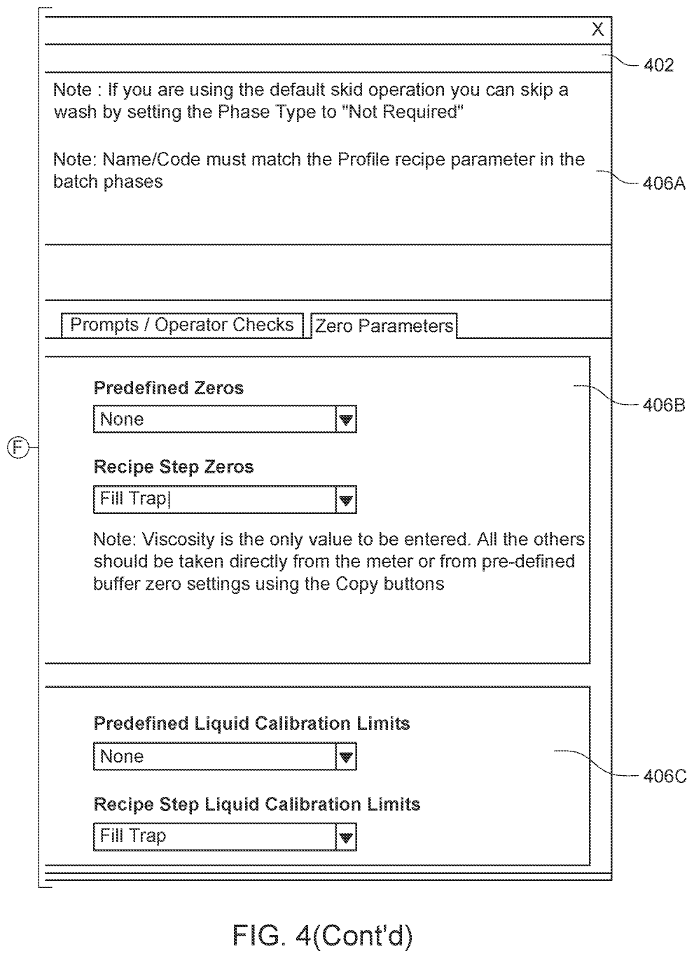

FIG. 4 is a user interface displayed on a client computing device in accordance with example embodiments. In general, user interface 400 is an example of the user interface 162 that can be displayed at user workstation 160 (shown in FIG. 1). The user interface 400 enables an operator to setup startup and purification recipe definitions and components by selecting a recipe and using pre-stored liquid and sensor parameters sets for a flow meter and air detector, as disclosed herein. User interface 400 can include a screen and display 402 (touch screen/display or other physical input) and a graphical user interface 404 with three selection areas 406A-C. First selection area 406A includes inputs to enable an operator to select steps in a recipe, such as a buffer elution recipe, by selecting a phase type, pump scheme, name/code of buffer elution and description of step of interest. Second selection area 406B includes inputs to enable an operator to select a liquid and sensor parameter set for a flow meter (e.g., zero and non-zero parameters) including, Viscosity, Window position, Gain 1, Gain 2, Up Surplus Time, Down Surplus Time, Differential Time, 1^{st} Threshold Level corresponding to the process liquid (e, g., elution buffer) used. The liquid and sensor parameters set can define or be associated with a waveform generated by a flow sensor to provide an accurate user readable flow rate output. The liquid and sensor parameter set generated during a startup recipe can be used in a purification recipe and/or sent to the flow meter transmitter to assure accuracy of flow rate readings. A snapshot of these sensor processing parameters can be taken during a startup operation/recipe as discussed herein. An operator can copy predefined zero parameters for the flow meter/sensor by inputting copy selections. For example, the viscosity value can be measured by a miscellaneous sensor or input by an operator as a value of 1, and all other parameters can be received directly from the flow meter sensor/transmitter settings or from pre-stored liquid and sensor parameters (e.g., zero settings) stored to create a liquid and sensor parameter modules during a startup operation. Additional operator inputs can be provided under different tabs including, flow path, flow, collection, collection conditions, alarms/links, prompts/operator checks and zero parameters. The third selection area 406C includes inputs to enable an operator to select an air detector liquid and sensor startup parameter set (e.g., zero values) including, liquid calibration limit for sensor 1 and sensor 2. An operator can copy these prestored liquid and sensor parameters (e.g., zero or non-zero parameters) from a liquid and sensor parameter module created during a startup operation and use them in a purification recipe or send them to the sensor transmitter to improve accuracy. User interface 404 further includes input button icons “Apply” and “Reset” to include their selections in a recipe of interest or change/reset their selections. These additional inputs can be incorporated in any of the selection areas 406A-C.

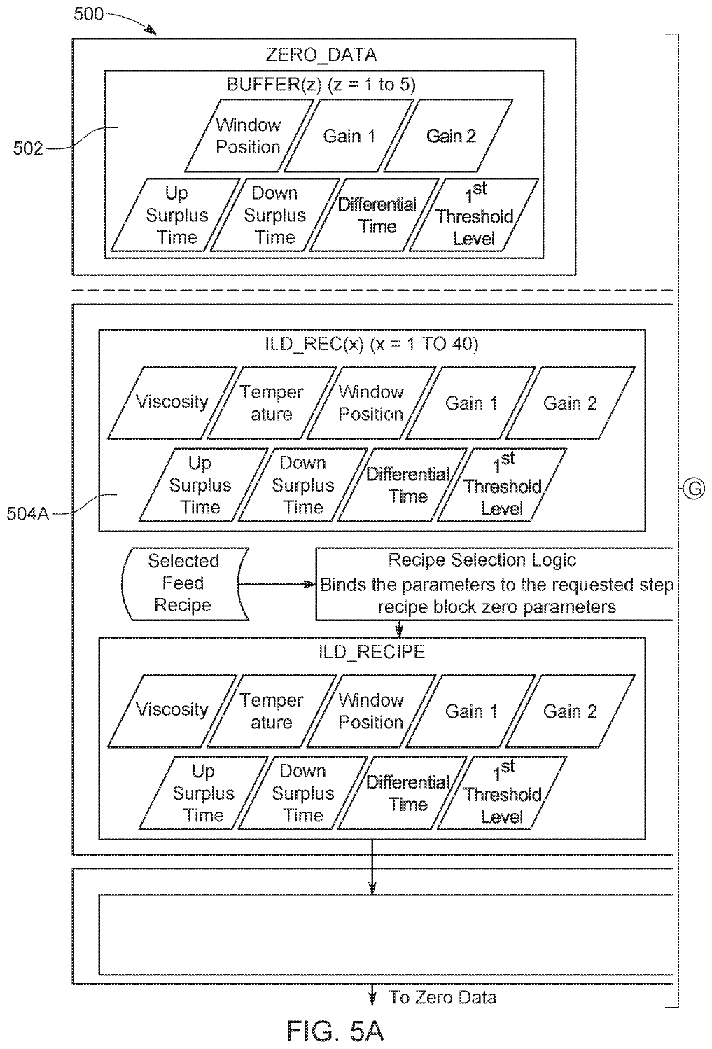

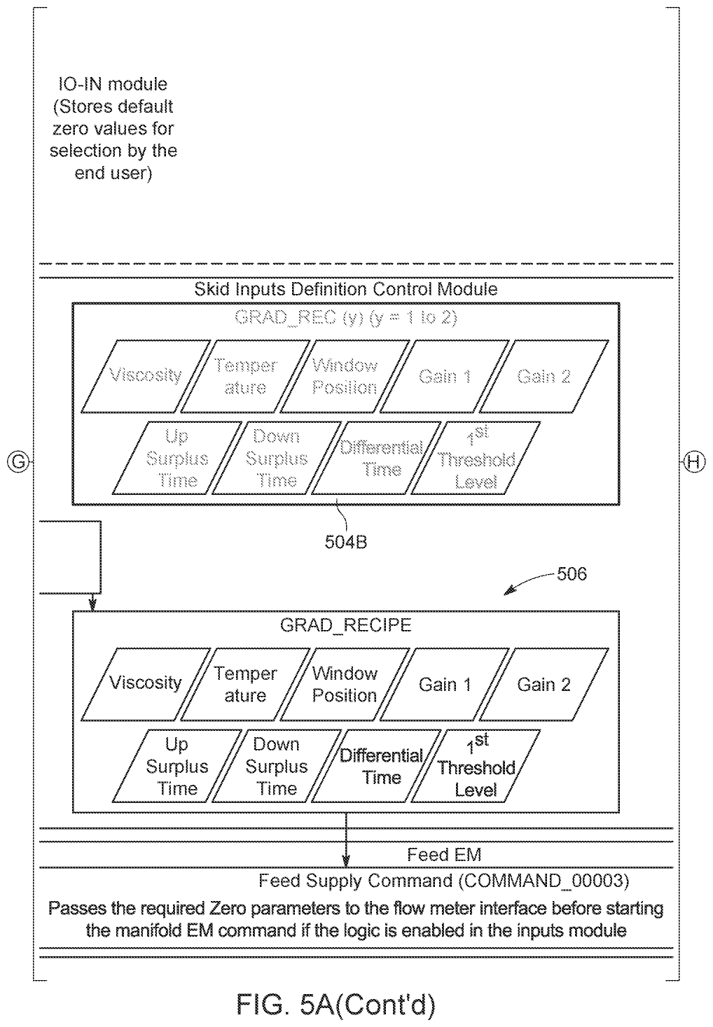

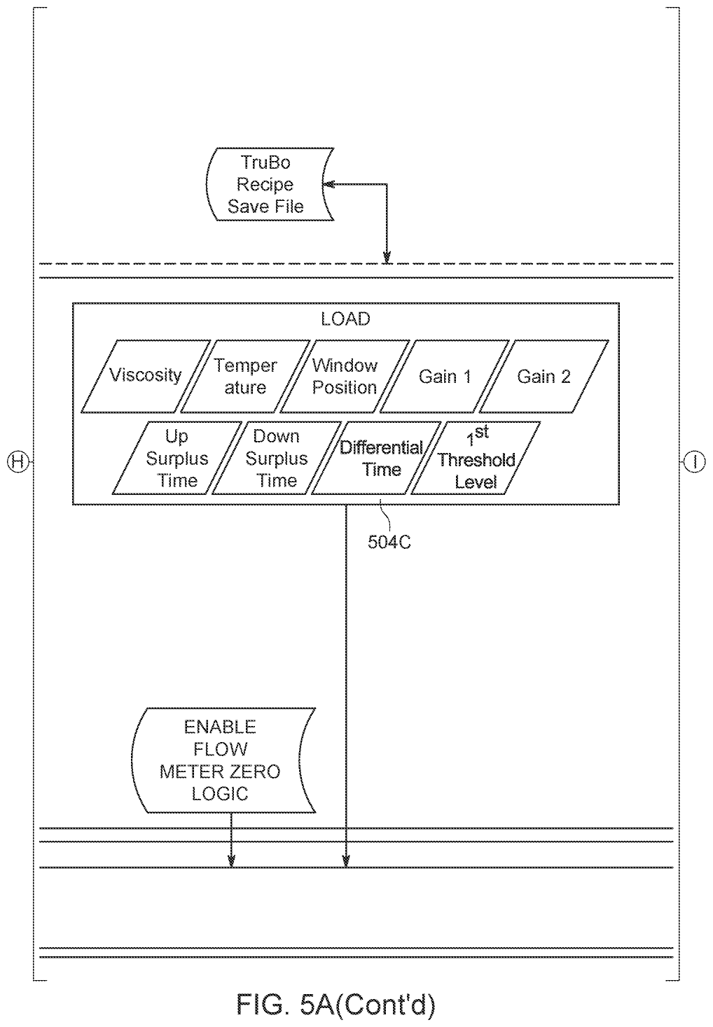

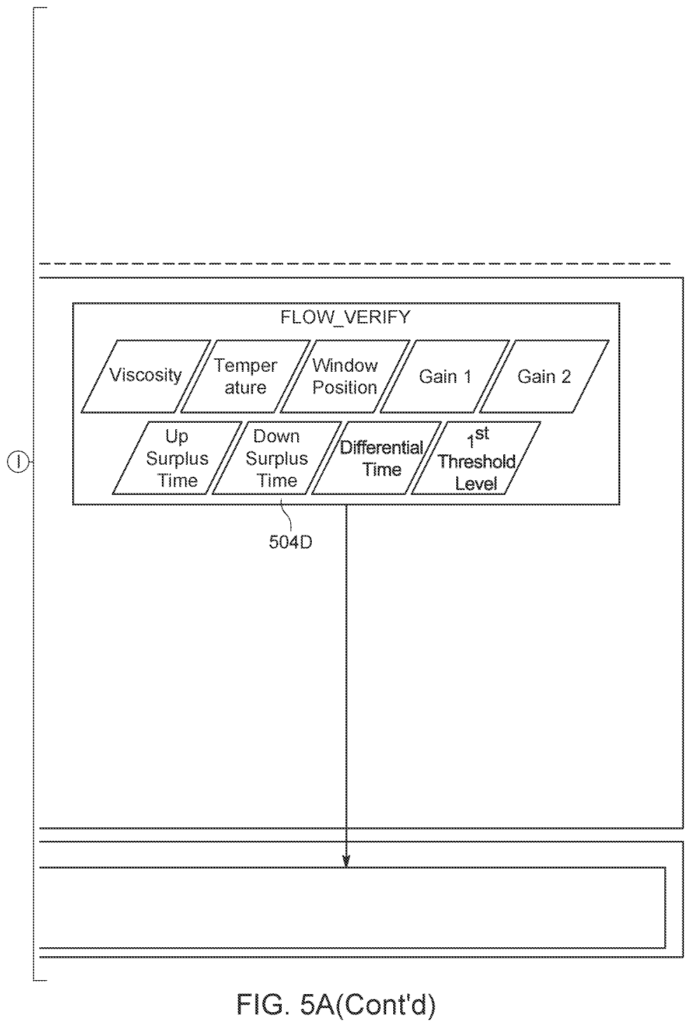

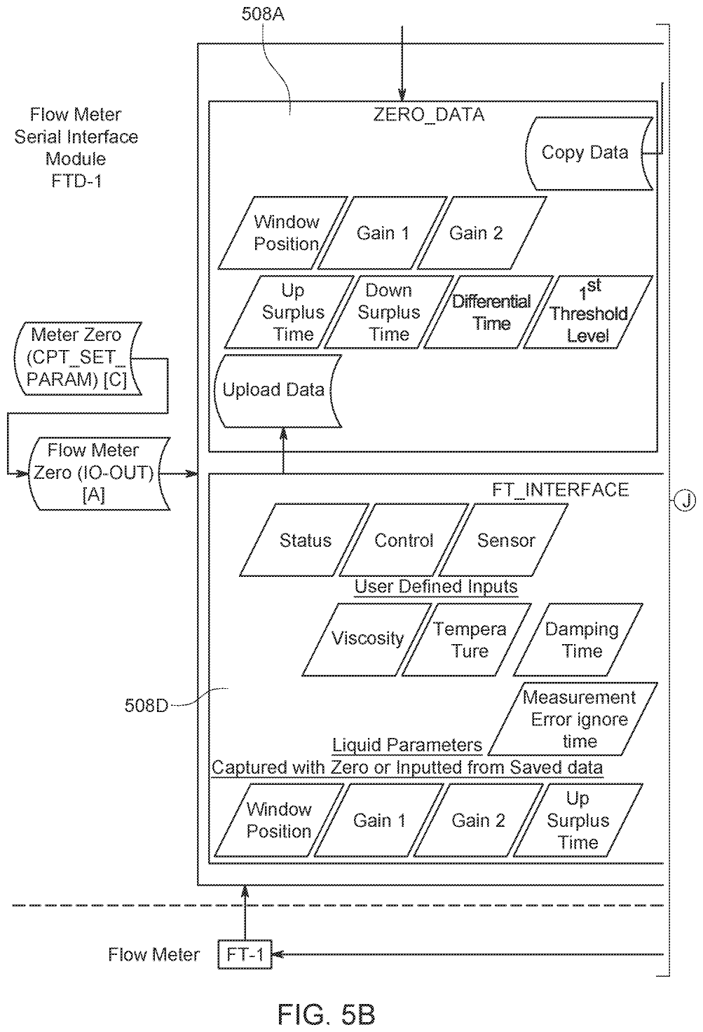

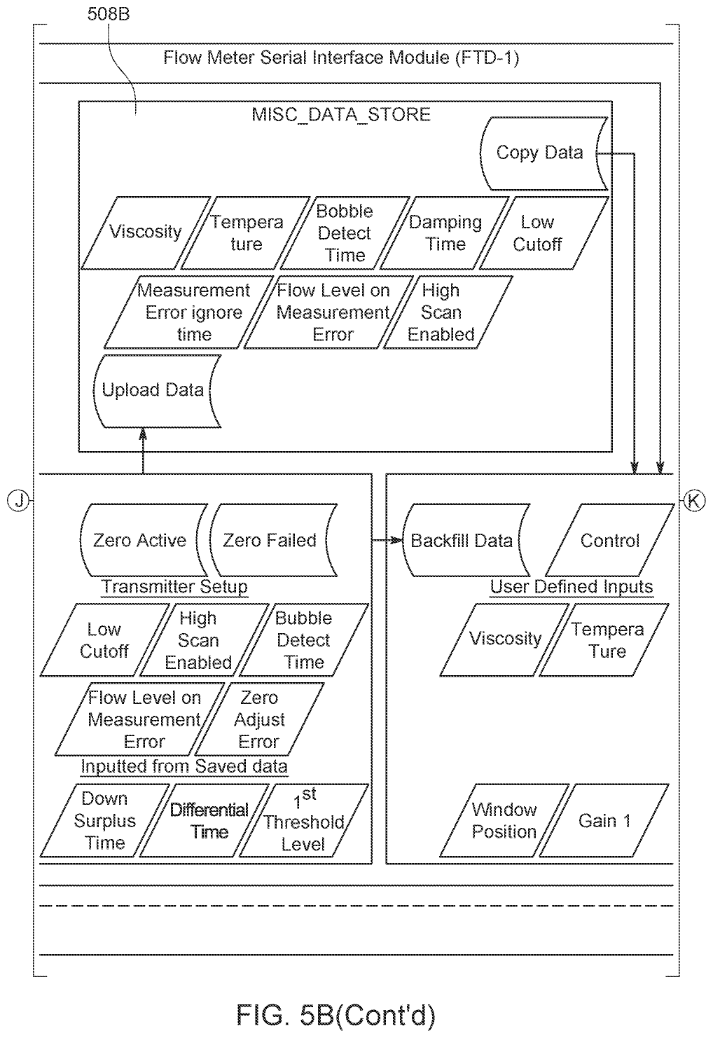

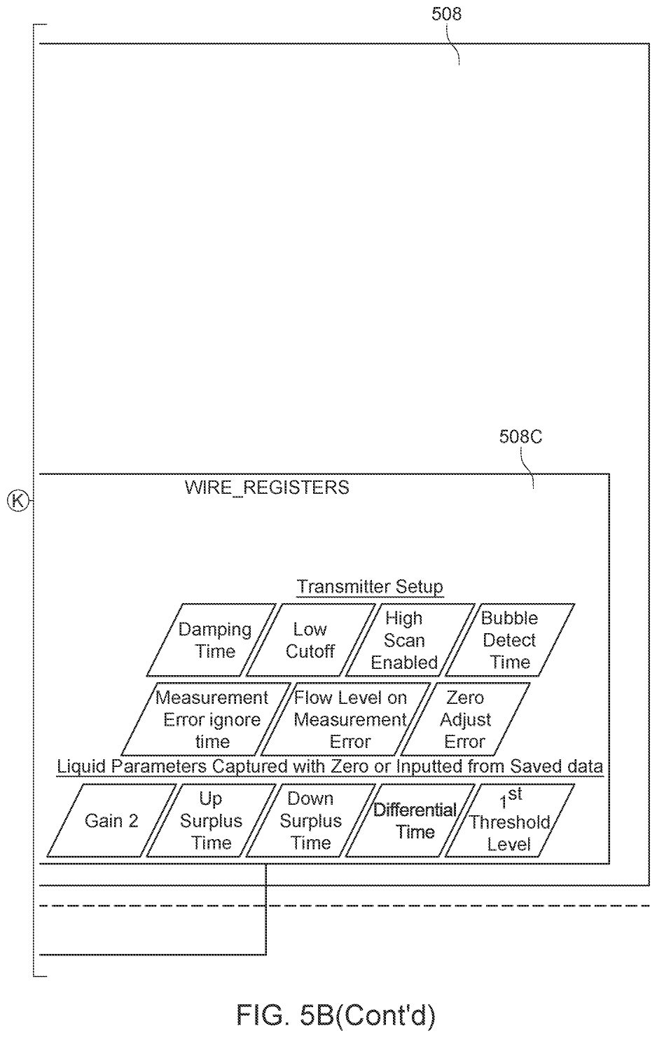

FIG. 5A is a block diagram of an input/output module 500 for a chromatography system in accordance with example embodiments. The input/output module 500 can be part of a system controller and stored in memory, for example, in the memory 114 of system controller 110 shown in FIG. 1A. The input/output module 500 communicates with operational components, peripherals, or equipment (e.g., pumps 146, valves 144, inlet/outlet manifolds 142, 154) and sensors 150 of chromatography unit 140 to automate a purification process. For example, input/output module 500 can cause system controller 110 (FIG. 1A) to send output signals to and receive/store input signals from operational components, peripherals, or equipment (e.g., pumps 146, valves 144, inlet/outlet manifolds 142, 154), sensors and associated transmitters of a chromatography unit, such as chromatography unit 140 shown in FIGS. 1A-1B. In addition, input/output module 500 can call, copy, and store liquid and sensor parameter sets and other parameters from other modules herein disclosed, for example, from the liquid and sensor parameter module 202 (FIG. 2A) or recipe module 206 (FIG. 2B).

A variety of liquid, buffer solution, system, equipment, and data processing parameters can be stored or input at the input/output module 500 to facilitate communication with and automation of equipment, sensors and purification processes of a chromatography system or unit. For example, the input/output module 500 can store liquid and sensor parameter sets generated by a startup process and recipe parameter sets for purification recipes. In an example embodiment, the input/output module 500 stores sensor (or transmitter) parameters 502 (e.g., zero set points) for one or more buffer solutions used in a specific purification process or recipe. These sensor parameters 502 can be copied, called, or stored from the liquid and sensor parameter module 202 shown in FIG. 2A. The input/output module 500 can also include a skid inputs definition control module, including in-line dilution (ILD) recipe parameters 504A, gradient elution recipe parameters 504B, LOAD parameters 504C, and FLOW parameters 504D used in recipes. Each set of parameters 504A-D can include a variety of process liquid, buffer, equipment, sensor or system parameters, such as viscosity of the buffer solution, the temperature of the buffer solution, and sensor transmitter parameters, such as window position, gain 1, gain 2, up surplus time, down surplus time, differential time, and 1^{st} threshold time. The viscosity and temperature of a buffer solution can be measured by sensors 150A-E and/or input by an operator on a user workstation 160. Sensor processing and waveform parameters, such as window position, gain 1, gain 2, up surplus time, down surplus time, differential time, and 1^{st} threshold time, can be generated by a sensor (e.g., flow meter) and stored to generate liquid and sensor parameter sets during a startup procedure discussed herein. The liquid and sensor parameter sets assure the accuracy of sensors in the chromatography system and the processing of data associated therewith.

Based on a selected purification recipe and associated logic, the input/output module 500 can bind or combine the purification recipe parameter sets and liquid and sensor parameter sets (e.g., zero values/adjusted buffer solution parameters 502) into one operational dataset 506. This operational data set 506, including purification recipe parameters and liquid and sensor parameters 502, can then be used to automate a purification process and/or sent to a sensor transmitter interface. In example embodiments, the operational data set 506 is sent to the flow meter interface module 508A illustrated in FIG. 5B, which can further send the operational data sets to a sensor transmitter.

FIG. 5B is a block diagram of a flow meter interface module 508 for interfacing with a flow meter in a chromatography system in accordance with example embodiments. The flow meter interface module 508 can be part of the system controller 100 logic and stored in memory 114 (shown in FIG. 1A). For example, flow meter interface module 508 can be part of the sensor interface module 124 shown in FIG. 1A. The flow meter interface module 508 manages all liquid and sensor parameter sets generated during a startup procedure, including read/write functions for reading and writing sensor transmitters settings that make up liquid and sensor parameter sets stored on the module 508 and sent to a flow meter transmitter to improve the accuracy of the flow meter. Any part of or the entire operational data set 506 of FIG. 5A can be transmitted to and stored at a zero data storage module 508A or miscellaneous data store 508B of a flow meter interface module 508. For example, the liquid and sensor parameter set 502 (FIG. 5A) can be transmitted to the zero data storage module 508A or miscellaneous data store 508B of a flow meter interface module 508 and used to overwrite the zero parameters of the flow meter by sending the parameters to one or more write registers 508C. The write registers 508C can send the liquid and sensor parameter set for storage at the flow transmitter interface 508D. The data can then be sent from the flow transmitter interface 508D to a transmitter of a flow meter (e.g., FT-1) to increase the accuracy of the flow meter.

The flow meter interface module 508 can also include a miscellaneous data store 508B that can receive and store transmitter set-up parameters to initialize the flow meter and form part of the liquid and sensor parameter sets created during a startup operation. In example embodiments, transmitter set-up parameters or miscellaneous parameters can include the viscosity of the process liquid (e.g., buffer solution), temperature of the liquid or buffer solution, bubble detect time, damping time, low cutoff, measurement error parameters, flow level parameters, and/or high-scan or rapid sensing enablement. One or more of the transmitter set-up parameters (e.g., miscellaneous parameters) can be received at miscellaneous data store 508B from a miscellaneous/auxiliary sensor 150E or through operator input. Transmitter set-up parameters received at miscellaneous data store 508B can be used to overwrite the transmitter set-up parameters of the flow meter by sending the transmitter set-up parameters to one or more write registers 508C. The write registers 508C can send the overwritten/adjusted liquid and sensor parameter sets, including miscellaneous transmitter set-up parameters to a transmitter of a flow meter to improve the accuracy of the flow meter and optimize the automation of a purification process in accordance with a purification recipe. Transmitter set-up parameters can also be used in a purification recipe to improve accuracy of one or more sensor without sending them to the sensors or associated transmitters.

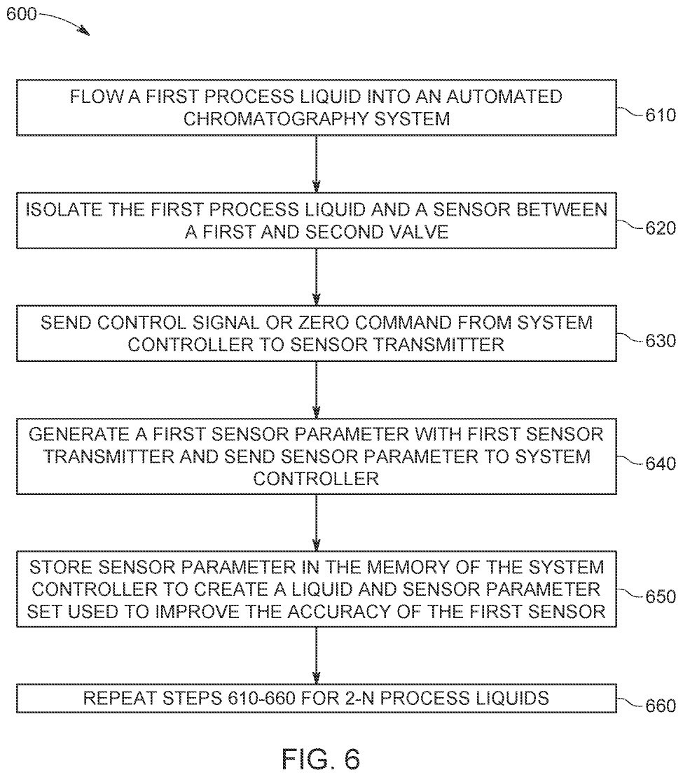

FIG. 6 is a flow diagram of a method 600 for operating a chromatography system 100 and chromatography unit 140 in accordance with a startup recipe. Aspects of the example chromatography system 100 and chromatography unit 140 depicted in FIG. 1A, and 1B can be utilized in the method steps described below. These example methods 600 may not recite the complete process or all steps of the method. Also, the steps need not necessarily all be performed, and in some cases, can be performed simultaneously or in a different order than the order shown.

At step 610, a first process liquid is flowed through a chromatography unit 140 of chromatography system 100 for automating a purification recipe. Chromatography system 100 includes a system controller 110 with a processor 112 and memory 114 for storing instructions, a first conduit 145 with a first inlet 142, a first valve 144E and a second valve 144F coupled to first conduit 145, a first sensor 150A (and transmitter) coupled to first conduit 145 (between the first valve 144E and a second valve 144E) and in electronic communication with system controller 110, and a first purification column 152A comprising a column inlet 151 fluidically coupled to first fluid conduit 145 downstream from first inlet 142. In some examples, a second sensor 150B and associated transmitter can be in electronic communication with system controller 110 and coupled to first conduit 145 between first valve 144E and a second valve 144F. In these examples, first sensor 150A or second sensor 150B can be a single-use sensor, analog sensor, level sensor, digital sensor, flow meter, air sensor, pH sensor, proximity sensor, temperature sensor, pressure sensor, conductivity sensor, ultrasonic sensor, or any other sensor capable of measuring fluid properties of process fluids or system properties. In other examples, a second purification column 152B is coupled to first fluid conduit 145 downstream from first column 152A.

At step 620, the first process liquid is isolated between first and second valves 144E, 144F where first sensor 150A is positioned. Isolating the first process liquid and first sensor 150A can include closing the first valve 144E and a second valve 144F and allowing the flow of the process liquid to stop between the valves. Each process liquid isolated can have the same or unique fluid properties, including, polarity, molarity, viscosity, density, viscosity, pH, conductivity, and other fluid properties.

At step 630, a system controller 110 can send a first control signal or zero-command to the transmitter of the first sensor 150A indicating the presence of air or the presence of the process liquid. The control signal or zero-command can cause a modification of a bit in a register of the sensor transmitter, for example from 0 to 1. In this zeroed state at step 640, the transmitter of the sensor 150A generates one or more sensor parameters (e.g., echo value or wave form parameter). In example embodiments, the first sensor can be an air sensor, flow sensor, or level sensor as disclosed herein.

At step 650, the one or more sensor parameters are stored in memory 114 of system controller 110 to form a liquid and sensor parameter set.

At step 660, steps 610-650 can be repeated for any number of process liquids and any number of sensors to create one or more liquid and sensor parameter sets (e.g., parameter sets 205A-N in FIG. 2A) for multiple liquids to create a library used to improve the accuracy of first sensor 150A. In some examples, liquid and sensor parameter sets include miscellaneous sensor measurements and sensor detection thresholds. The liquid and sensor parameter sets are specific to a process liquid and sensor and can be sent to a specific sensor transmitter or used in a purification recipe to improve the accuracy of the sensor and process automation.

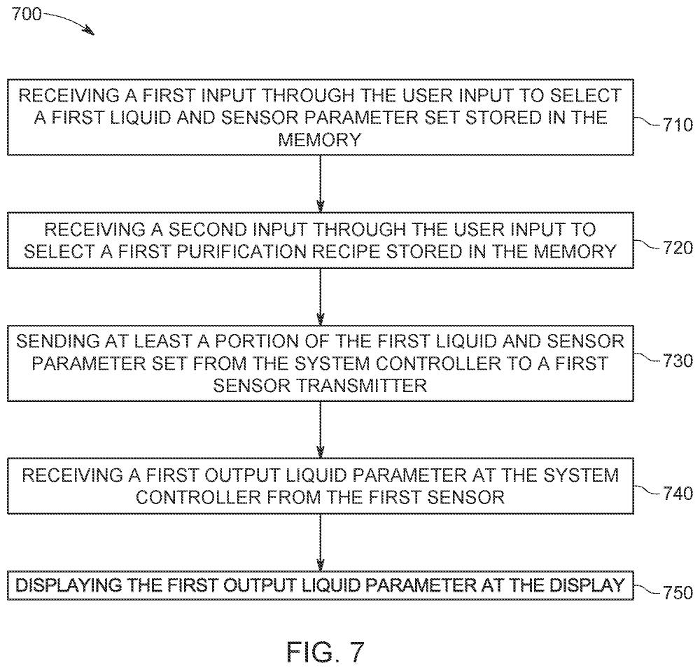

FIG. 7 is a flow diagram of a method 700 for operating a chromatography system 100 and chromatography unit 140 in accordance with a purification recipe. Aspects of the example chromatography system 100 and chromatography unit 140 depicted in FIG. 1A, and 1B can be utilized in the method steps described below. These example methods 700 may not recite the complete process or all steps of the method. Also, the steps need not necessarily all be performed, and in some cases can be performed simultaneously or in a different order than the order shown.

At step 710, a first input through the user input is received to select a first liquid and sensor parameter set stored in the memory. An operator can use a user workstation 160 to additionally select a second to nth liquid and sensor parameter sets stored in the memory. Each liquid and sensor parameter set can correspond to a specific process liquid (e.g., feed stream, injected water, buffer solution, or product stream) and sensor (e.g., air sensor, flow sensor, or proximity sensor).

At step 720, a second input is received through the user input (or workstation 160) to select a first purification recipe stored in the memory. Any number of nth recipes can be selected from storage. Each of the recipes can include several steps that control the operation of the chromatography system and purification of a target molecule.

At step 730, at least a portion of the first liquid and sensor parameter set is sent from the system controller 110 to a first sensor or transmitter of a first sensor. Step 730 can also include overwriting a parameter set stored at a sensor interface module or at a sensor transmitter with at least a portion of the first liquid and sensor parameter set. In some examples, the first liquid and sensor parameter set can simply be used in the purification recipe to control automation.

At step 740, a first output liquid parameter 204A4 is received at the system controller from the first sensor. At step 750, the first output liquid parameter is displayed at a display of a user interface.

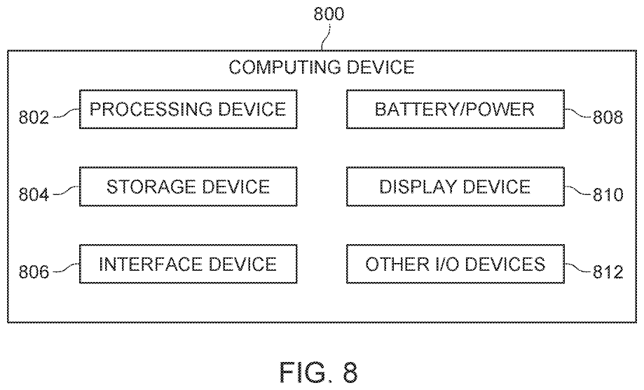

FIG. 8 depicts a block diagram of an example computing device 800 that can perform some or all operations of an automated chromatography system, user computing device(s), processing unit(s) and/or controller(s) in accordance with the example embodiments. The example chromatography systems, system controller including controllers, modules, libraries, data repositories, disclosed herein can include or be implemented by one or more computing devices. In some embodiments, the example user computing device or workstation 160, controller 110 include a single computing device 800 or multiple computing devices 800. Further, as discussed below, a computing device 800 (or multiple computing devices 800) that implements the example automated chromatography control systems, modules, data repositories, and libraries can be part of one or more chromatography unit 140, user or client computing devices 160 with user interfaces 162, processors 112 and controllers 110, a user's local computing device, a service provider's local computing device, or a remote computing device. Client computing devices or user workstation 160, processing units 112 and controllers 110, can also be contained in a unitary computing system or server with a user interface or distributed over servers and systems.

The computing device 800 of FIG. 8 is illustrated as having a number of components, but any one or more of these components may be omitted or duplicated, as suitable for the application and setting. In some embodiments, some or all of the components included in the computing device 800 can be attached to one or more motherboards and enclosed in a housing (e.g., including plastic, metal, and/or other materials). In some embodiments, some of these components may be fabricated onto a single system-on-a-chip (SoC) (e.g., an SoC may include one or more processing devices 802 and one or more storage devices 804). Additionally, in various embodiments, the computing device 800 may not include one or more of the components illustrated in FIG. 8, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 800 may not include a display device 810, but may include display device interface circuitry (e.g., a connector and driver circuitry) to which a display device 810 may be coupled.

The computing device 800 can include a processing medium or device 802 (e.g., one or more processing devices). As used herein, the term “processing device” refer to any device or portion of a device that processes electronic data from registers and/or memory to transform that electronic data into other electronic data that may be stored in registers and/or memory. The processing device 802 can include one or more digital signal processors (DSPs), application-specific integrated circuits (ASICs), central processing units (CPUs), graphics processing units (GPUs), crypto processors (specialized processors that execute cryptographic algorithms within hardware), server processors, or any other suitable processing devices.

The computing device 800 can also include a storage device 804 (e.g., one or more storage devices). The storage device 804 can include one or more memory devices such as random-access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 804 can include memory that shares a die with a processing device 802. In such an embodiment, the memory can be used as cache memory and can include embedded dynamic random-access memory (cDRAM) or spin transfer torque magnetic random-access memory (STT-MRAM), for example. In some embodiments, the storage device 804 can include non-transitory computer readable media having instructions thereon that, when executed by one or more processing devices (e.g., the processing device 802), cause the computing device 800 to perform any appropriate ones of or portions of the methods and operations disclosed herein.

The computing device 800 can include an interface device 806 (e.g., one or more interface devices 806). The interface device 806 can include one or more communication chips, connectors, and/or other hardware and software to govern communications between the computing device 800 and other computing devices. For example, the interface device 806 can include circuitry for managing wireless communications for the transfer of data to and from the computing device 800. The term “wireless” and its derivatives are used to describe circuits, devices, systems, methods, techniques, communications channels, etc., that can communicate data through the use of modulated electromagnetic radiation through a nonsolid medium. The term does not imply that the associated devices do not contain any wires, although in some embodiments they might not. Circuitry included in the interface device 806 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some embodiments, circuitry included in the interface device 806 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 806 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 806 for managing wireless communications can operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 can include one or more antennas (e.g., one or more antenna arrays) to receipt and/or transmission of wireless communications.

In some embodiments, the interface device 806 can include circuitry for managing wired communications, such as electrical, optical, or any other suitable communication protocols. For example, the interface device 806 can include circuitry to support communications in accordance with Ethernet technologies. In some embodiments, the interface device 806 can support both wireless and wired communication, and/or may support multiple wired communication protocols and/or multiple wireless communication protocols. For example, a first set of circuitries of the interface device 806 can be dedicated to shorter-range wireless communications such as Wi-Fi or Bluetooth, and a second set of circuitries of the interface device 806 can be dedicated to longer-range wireless communications such as global positioning system (GPS), EDGE, GPRS, CDMA, WiMAX, LTE, EV-DO, or others. In some embodiments, a first set of circuitries of the interface device 806 can be dedicated to wireless communications, and a second set of circuitries of the interface device 806 can be dedicated to wired communications.

The computing device 800 can include battery/power circuitry 808. The battery/power circuitry 808 can include one or more energy storage devices (e.g., batteries or capacitors) and/or circuitry for coupling components of the computing device 800 to an energy source separate from the computing device 800 (e.g., AC line power).

The computing device 800 can include a display device 810 (e.g., multiple display devices). The display device 810 can include any visual indicators, such as a heads-up display, a computer monitor, a projector, a touchscreen display, a liquid crystal display (LCD), a light-emitting diode display, or a flat panel display.

The computing device 800 can include other input/output (I/O) devices 812. The other I/O devices 812 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 800, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 800 can have any suitable form factor for its application and setting, such as a handheld or mobile computing device (e.g., a cell phone, a smart phone, a mobile internet device, a tablet computer, a laptop computer, a netbook computer, an Ultrabook computer, a personal digital assistant (PDA), an ultra-mobile personal computer, etc.), a desktop computing device, or a server computing device or other networked computing component.

The different embodiments and examples of the chromatography systems and methods described herein provide several advantages over known solutions for purifying a target molecule from a mixture on a column chromatography system. For example, illustrative embodiments and examples described herein allow for smooth operation of recipes on column chromatography by automation, especially in cases where the process includes a gradient elution with the buffer solution varying in a range of polarity.

Additionally, and among other benefits, illustrative embodiments and examples described herein allow for reducing buffer solution wastage while operating a recipe for purification of the target molecule, by storing a fluid property of the buffer solution measured by a sensor as a zero-setting parameter and running recipes by including the zero-setting parameters.

Additionally, and among other benefits, illustrative embodiments and examples described herein prevent false sensor alarms while operating a recipe by characterizing each buffer solution by fluid-type and sensor-type measurements and using the characterization data at appropriate stages of the recipe.

Additionally, and among other benefits, illustrative embodiments and examples described herein allow to avoid by-passing of columns due to false alarm readings recorded by sensors.

Additionally, and among other benefits, illustrative embodiments and examples described herein are configured to provide a complete, single-use solution for chromatography purification in downstream bioprocessing of recombinant proteins such as monoclonal antibodies and viral vector production.

Additionally, and among other benefits, illustrative embodiments and examples described herein allow for using single-use ultrasonic flow sensor, and air sensors located upstream from the column to monitor flow rate and air concentration of buffer solutions flowing through the column, respectively.

Additionally, and among other benefits, illustrative embodiments and examples described herein allow for continuous feed stream processing on a multi-column chromatography system.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. A method of automating a chromatography system comprising:
flowing a first liquid into the chromatography system, the chromatography system comprising:
a system controller with a processor and memory for storing instructions;
a first conduit with a first inlet;
a first valve and a second valve coupled to the conduit;
a first sensor coupled to the first conduit and a first sensor transmitter in electronic communication with the system controller; and
a first purification column comprising a column inlet fluidically coupled to the first fluid conduit downstream from the first inlet;
isolating the first liquid between the first valve and the second valve;
generating a first sensor parameter at the first sensor transmitter;
sending the first sensor parameter from the first sensor transmitter to the system controller; and
storing the first sensor parameter in the memory to create a first liquid and sensor parameter set used to improve an accuracy of the first sensor.

2. The method recited in claim 1, wherein the first sensor parameter is a processing parameter used to calculate a first liquid parameter of the first liquid.

3. The method recited in claim 1, further comprising sending a first command signal from the system controller to the first sensor transmitter, indicating a presence of the first liquid proximate to the first sensor.

4. The method recited in claim 1, further comprising sending the first liquid and sensor parameter set to the first transmitter associated with the first sensor.

5. The method recited in claim 2, wherein the first sensor is a flow sensor and the first liquid parameter is a flow rate of the first liquid.

6. The method as recited in claim 2, wherein the first sensor is an air sensor and the first liquid parameter indicates an air concentration in the first liquid.

7. The method as recited in claim 2, wherein the chromatography system further comprises a bubble trap, the first sensor is a level sensor positioned proximate to the bubble trap, and the first liquid parameter indicates a presence of liquid in the bubble trap.

8. The method recited in claim 1, wherein the chromatography system further comprises a second sensor coupled to the first conduit and a second sensor transmitter in electronic communication with the system controller.

9. The method recited in claim 8, further comprising:
generating a second sensor parameter at the second sensor transmitter;
sending the second sensor parameter from the second sensor transmitter to the system controller; and
storing the second sensor parameter in the memory to create a second liquid and sensor parameter set used to improve an accuracy of the second sensor.

10. The method recited in claim 9, wherein the second sensor parameter is a processing parameter used to calculate a second liquid parameter of the first liquid.

11. The method recited in claim 9, further comprising sending a second command signal from the system controller to the second sensor transmitter, indicating a presence of the first liquid proximate to the second sensor.

12. The method recited in claim 9, further comprising sending the second liquid and sensor parameter set to the second sensor transmitter associated with the second sensor.

13. The method recited in claim 9, wherein the second sensor is a flow sensor and the second liquid parameter is a flow rate of the second liquid.

14. The method as recited in claim 9, wherein the second sensor is an air sensor and the second liquid parameter is an air concentration in the second liquid.

15. The method as recited in claim 9, wherein the chromatography system further comprises a bubble trap, the second sensor is a level sensor positioned proximate to the bubble trap, and the second liquid parameter indicates a presence of liquid in the bubble trap.

16.-40. (canceled)

41. An automated chromatography system comprising:
a controller comprising a processor and memory for storing operational instructions and controlling system components;
a first conduit with an inlet;
a first pump in fluid communication with the inlet;
a first valve and a second valve in fluid communication with the first conduit and in electronic communication with the controller;
a first sensor coupled to the first conduit and a first sensor transmitter in electronic communication with the controller;
a first purification column comprising a column inlet downstream from and in fluid communication with the first inlet; and
a first liquid and sensor parameter set stored in the memory, corresponding to a first liquid and the first sensor, and for improving an accuracy of the first sensor.

42. The automated chromatography system recited in claim 41, further comprising a sensor startup operation comprising operational instructions stored in the memory to cause the controller to:
operate the pump and flow the first liquid through the first inlet and into the first conduit;
close the first and the second valves to isolate the first liquid between the first and second valves;
receive, at the system controller, a first sensor parameter from the first sensor transmitter; and
store the first sensor parameter in the memory to create the first liquid and sensor parameter set.

43. The automated chromatography system recited in claim 41, further comprising:
a second sensor coupled to the first conduit;
a second sensor transmitter in electronic communication with the controller; and
a second liquid and sensor parameter set stored in the memory, corresponding to a second liquid and the second sensor, and for improving an accuracy of the second sensor.

44. The automated chromatography system recited in claim 43, wherein the sensor startup operation further comprises operational instructions stored in the memory to cause the controller to:
operate the pump and flow the second liquid through the first inlet and into the first conduit;
close the first and the second valves to isolate the second liquid between the first and second valves;
receive, at the system controller, a second sensor parameter from the second sensor transmitter; and
store the second sensor parameter in the memory to create the second liquid and sensor parameter set.

45. The automated chromatography system recited in claim 43, wherein the first sensor and the second sensor are an air sensor, a flow sensor, or a level sensor.

46.-66. (canceled)
